(19) United States
(12) Patent Application Publication
(10) Pub. No.: US 2026/0225934 A1
(43) Pub. Date: Aug. 6, 2026

(54) WATER DESALINATION SYSTEMS

(71) Applicant: Badwater Alchemy Technologies Inc., Seattle, WA (US)

(72) Inventors: William J. Walker, Seattle, WA (US); Mark T. Calvert, Seattle, WA (US)

(73) Assignee: Badwater Alchemy Technologies Inc., Seattle, WA (US)

(21) Appl. No.: 19/157,255

(22) PCT Filed: Feb. 16, 2024
(86) PCT No.: PCT/US2024/016202

§ 371 Date: Aug. 15, 2025

Related U.S. Application Data
(60) Provisional application No. 63/446,488, filed on Feb. 17, 2023.

(51) Int. Cl. C02F 9/00; C02F 1/00; C02F 1/02; C02F 1/28; C02F 1/48; C02F 1/66; C02F 1/72; C02F 1/74; C02F 101/00; C02F 101/10; C02F 101/12; C02F 101/16; C02F 101/20; C02F 103/08; C02F 103/10; C02F 103/26

(52) U.S. Cl. CPC C02F 9/00; C02F 1/008; C02F 1/02; C02F 1/281; C02F 1/283; C02F 1/488; C02F 1/66; C02F 1/727; C02F 1/74; C02F 2101/006; C02F 2101/101; C02F 2101/103; C02F 2101/105; C02F 2101/106; C02F 2101/12; C02F 2101/163; C02F 2101/206; C02F 2103/08; C02F 2103/10; C02F 2103/26; C02F 2201/005; C02F 2209/05; C02F 2209/06; C02F 2303/18; C02F 2305/08

(57) ABSTRACT

Systems, devices, and techniques described herein relate to iron-based desalination of water. In some cases, an inflow of water including chloride and sodium can be received. A plurality of iron nanoparticles may capture the chloride and the sodium. The iron nanoparticles may at least partially include Zero Valent Iron (ZVI). An outflow of the water may be emitted. The chloride and the sodium may be omitted from the outflow.

### CROSS-REFERENCE TO RELATED APPLICATIONS

This application is the 35 U.S.C. § 371 National Phase of International App. No. PCT/US2024/016202, filed on Feb. 16, 2024, which claims priority to U.S. Provisional App. No. 63/446,488, which was titled “Water Desalination Systems,” filed on Feb. 17, 2023, each of which is incorporated by reference herein in its entirety.

### BACKGROUND

The vast majority of the Earth's water is saline. Some sources estimate that only about 2.5% of the Earth's water is freshwater. Saline water (defined as the sum of sodium and chloride content) however, is typically unusable as drinking water and for many agricultural uses. According to the United Nations (UN), 14% of the world's population will encounter water scarcity by 2025. Some communities, such as Saudi Arabia and Kuwait, already rely on desalination to supply drinking water and fresh water for agricultural uses.

With the increasing pressure to find usable water resources for drinking, industrial, agricultural, and livestock uses, a variety of technologies are in development to improve water quality. Various governmental agencies, such as the United States (US) Environmental Protection Agency (EPA) require factories to reduce an amount of Total Dissolved Solids (TDS) in wastewater. TDS include various ions and particles that can pass through a filter with pores of around 0.45 microns in size. Water with a high TDS level can significantly disrupt the water balance of biological cells, which can sometimes lead to death. In addition, water with a high TDS level may be opaque, which may reduce photosynthesis in plants exposed to the water. A high TDS level may also increase water temperature. Accordingly, the US EPA requires agricultural water to have a TDS of 1,500 milligrams per liter (mg/L) or less and drinking water to have a TDS of 500 mg/L or less. Because most of the earth's surface water and groundwater exceeds these standards, most surface water and groundwater is unsuitable for agricultural, industrial, or drinking uses. Desalination technologies are increasingly essential for providing safe water to farms and individuals throughout the world. Desalination techniques are also required by many industries that produce saline water as a result of industrial processes.

Various desalination technologies have been utilized to remove salt ions from saline water. One example technique is distillation. In a distillation process, saline water can be heated, leading to water evaporation. The evaporated water can be condensed and collected as desalinated water. Another example desalination technique is Reverse Osmosis (RO). In an RO process, saline water is pressurized on a first side of a water-permeable membrane. Solute in the saline water (e.g., salt) remains on the first side (brine or reject), and substantially pure water (permeate) can pass through to the second side of the water-permeable membrane through the membrane itself. In addition to distillation and RO, Ion Exchange (IX) and electrodialysis may be used to desalinate water.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example desalination system in accordance with various implementations of the

FIG. 2 illustrates an example environment for controlling a desalination system.

FIGS. 3A and 3B illustrate examples of iron nanoparticles configured to adsorb sodium (Na) and chlorine (Cl) atoms.

FIG. 4A illustrates an example process for dynamically controlling a desalination system. FIG. 4B illustrates an example process for removing at least one solute from water.

FIG. 5 illustrates an example of a desalination tank.

FIG. 6 illustrates exploded and interior views of an example desalination tank in accordance with various implementations of the present disclosure.

FIG. 7 illustrates a first view of an example desalination system including multiple example desalination tanks.

FIG. 8 illustrates a second view of the example desalination system including multiple desalination tanks.

FIG. 9 illustrates a view of two desalination tanks that can be arranged in a side-by-side fashion in an example desalination system.

FIG. 10 illustrates a side view of an example desalination system including multiple desalination tanks.

FIG. 11 illustrates various views of a settling tank of an example desalination system.

FIG. 12 illustrates a schematic of an example desalination system including multiple desalination tanks at a first view.

FIG. 13 illustrates a schematic of an example desalination system including multiple desalination tanks at a second view.

FIG. 14 illustrates a schematic of an example desalination system including multiple desalination tanks at a third view.

FIG. 15 illustrates an example of a multiple desalination systems housed in rectangular containers and stacked from a first view.

FIG. 16 illustrates an example of a multiple desalination systems housed in rectangular containers and stacked from a second view.

FIG. 17 illustrates an example group of desalination tanks that can be included in a desalination system.

FIG. 18 illustrates a first cross-sectional view of a group of desalination tanks that can be included in a desalination system.

FIG. 19 illustrates a second cross-sectional view of a group of desalination tanks that can be included in a desalination system.

FIG. 20 illustrates a third cross-sectional view of a group of desalination tanks that can be included in a desalination system.

FIG. 21 illustrates an example schematic of a desalination system that utilizes nano media and compressed air to desalinate water.

FIG. 22 illustrates at least one example device configured to enable and/or perform various functionality discussed herein.

### DETAILED DESCRIPTION

Various systems, devices, and methods described herein relate to improved techniques for removing solutes from water. In particular cases, water can be efficiently and quickly desalinated using various techniques described herein.

In various implementations, a desalination system includes one or more desalination tanks that receive saline water. A desalination media, such as a slurry containing zero valent iron (ZVI) nanoparticles, is input into the desalination tank(s). In addition, an oxidizing agent is introduced into the desalination tank(s). In particular cases, the oxidizing agent incudes a gas that produces bubbles in a fluid mixture of the saline and desalination media in the desalination tank(s). Solutes in the saline water are captured and/or removed due to the presence of the desalination media. For instance, oxidation of the ZVI nanoparticles results in capture of solutes such as sodium and chloride ions in the saline. The oxidizing agent, in various cases, can greatly increase the speed and efficiency of solute capture by the ZVI nanoparticles. For instance, using techniques described herein, at least 80% of sodium and chloride can be removed from saline water in less than one day (e.g., eight to 10 hours).

In various cases described herein, the desalination tank(s) are part of a continuous, feed-through desalination system. For example, the desalination tank(s) are part of a fluid circuit that receives saline water at an inlet and produces desalinated water at an outlet. Various structures within the desalination system can enhance the speed and efficiency of the continuous system. These structures optionally include baffles, one or more settling tanks, physical filters, valves, pumps, or any combination thereof. In some cases, a standalone desalination system described herein can be transported to a remote site (e.g., in a boxcar or other modular housing) and used to treat water with minimal energy expenditure.

Various implementations of the present disclosure will now be described with reference to the accompanying figures.

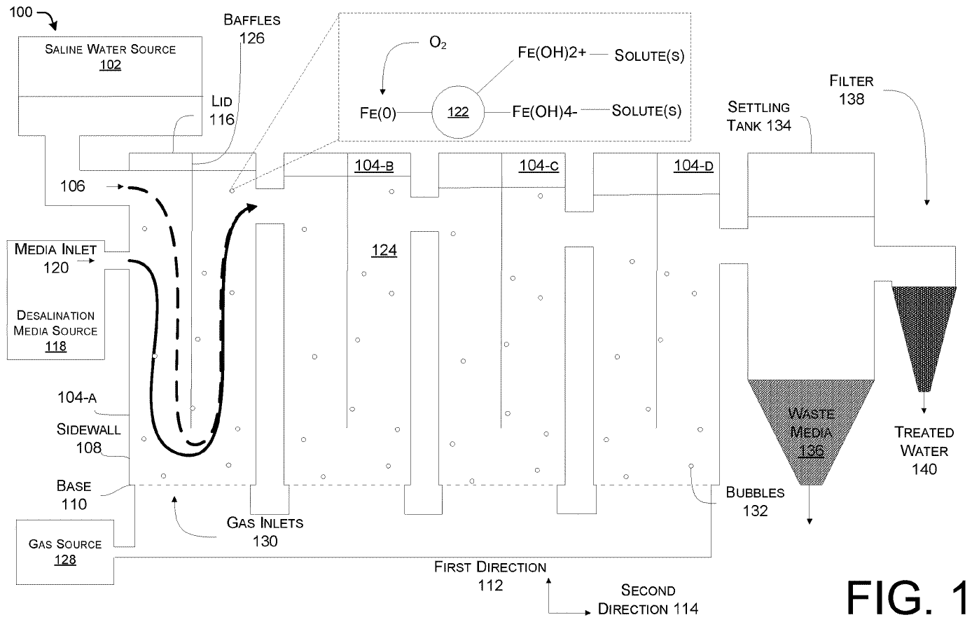

FIG. 1 illustrates an example desalination system 100 in accordance with various implementations of the present disclosure. The desalination system 100 receives saline water from a saline water source 102. That is, the saline water may be influent water into the desalination system 100. As used herein, the terms “saline,” saline water,” and their equivalents, may refer to an aqueous solution including dissolved salts, metals, solids, other contaminants, or any combination thereof at greater than a threshold concentration (e.g., greater than 3% salinity). In various cases, saline water is unfit for human and/or animal consumption. For instance, saline may include seawater, industrial waste, mining waste, agricultural waste, or any combination thereof. In some examples, saline water includes brine. As used herein, the term “brine,” and its equivalents, may refer to an aqueous solution having greater than 5% salinity. The saline water source 102, for instance, includes a tank. In some cases, the saline water source 102 includes one or more pipes, pumps, tanks, valves, or other structures by which saline water can be transported to the desalination system 100.

The saline water enters a first desalination tank 104-a through a water inlet 106, which is fluidly coupled to the saline water source 102. In the example illustrated in FIG. 1, the water inlet 106 extends through a sidewall 108 of the first desalination tank 104-a. The sidewall 108 extends from a base 110 of the first desalination tank 104-a. The sidewall 108 may be parallel to a first direction 112 and the base 110 may be parallel to a second direction 114, wherein the first direction crosses the second direction. During operation of the desalination system 100, the first direction 112 may be opposite of a direction of gravity. In some cases, the sidewall 108 is perpendicular to the base 110. In some examples, the base 110 has a polygonal (e.g., rectangular) and/or circular shape. A lid 116 may be removably coupled to the sidewall 108. The sidewall 108, base 110, and lid 116 include one or more materials configured to contain water, such as saline water. In some examples, the sidewall 108 and base 110 include a metal (e.g., stainless steel), a polymer (e.g., polyethylene), glass, or any combination thereof.

In various implementations, a desalination media source 118 outputs a desalination media into the first desalination tank 104-a via a media inlet 120. In the example illustrated in FIG. 1, the media inlet 120 extends through the sidewall 108 of the first desalination tank 104-a. However, in some cases, the media inlet 120 extends through the lid 116 of the first desalination tank 104-a. The desalination media is configured to capture one or more solutes in the saline water output from the saline water source 102.

The desalination media, in various cases, includes a slurry containing metal nanoparticles. In some cases, the slurry includes iron nanoparticles 122. For example, the iron nanoparticles include zero valent iron (ZVI). The slurry, for instance, includes a mixture of water and nanoparticles. In some cases, the slurry includes additional materials.

As used herein, the term “nanoparticle,” and its equivalents, can refer to a solid particle that is shorter than 100 nanometers (nm) in at least one dimension. In some cases, a nanoparticle can have a diameter of less than 100 nm. An iron nanoparticle, for example, can be a nanoparticle including (and possibly consisting of) iron atoms. In some cases, an iron nanoparticle may include a network structure of iron atoms that are covalently bonded to each other. The network structure may be cubic. In some cases the iron nanoparticles may be mixed with aluminum, magnesium and/or copper nanoparticles.

As used herein, a “size,” “length,” “diameter,” or their equivalents of a particle may refer to a Z-average diameter (e.g., as determined using Dynamic Light Scattering (DLS)). In some cases, a “size,” “length,” “diameter,” or their equivalents, of multiple particles may refer to a Z-average diameter in which the particles have a weighted differential size distribution within ±10% of the Z-average diameter. In various implementations described herein, the iron nanoparticles may, for instance, may be assumed to have spherical shapes, such that a Z-average diameter of the nanoparticles (e.g., generated using DLS) in suspension may be between 1 and 100 nm. In some cases, the nanoparticles may have a Z-average diameter that is between 40 to 60 nm, such as about 50 nm. In some implementations, at least 90% of a (volume or intensity) weighted differential size distribution of the nanoparticles in solution (e.g., generated using DLS) may be between 20 and 80 nm, such as about 50 nm. In some cases, a particle's length can be defined by microscope measurements (e.g., via at least one optical microscope, an electron microscope, a scanning probe microscope, or the like), settling velocities (e.g., by applying Stokes' law to a measured velocity of the particle), and/or sedimentation methods.

In various instances, the nanoparticles may include ZVI. As used herein, the term “Zero Valent Iron (ZVI),” “zerovalent iron,” “nonvalent iron,” “Fe(0 ),” and their equivalents, can refer to one or more iron atoms with a valency of zero. In some cases, iron can change between a zerovalent state and a multivalent state, such as the trivalent Fe³⁺form.

When ZVI atoms on the surface of the nanoparticles become oxidized, the atoms may be converted into multivalent iron atoms. As used herein, the term “oxidation,” and its equivalents, can refer to a chemical reaction in which at least one atom loses electrons. As used herein, the term “reduction,” and its equivalents, can refer to a chemical reaction in which at least one atom gains electrons. In a “reduction-oxidation” or “redox” reaction, electrons are transferred from one chemical species (e.g., a species undergoing oxidation) to another chemical species (e.g., a species undergoing reduction). For example, ZVI can be oxidized according to the following Equation 1: yields

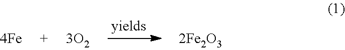

wherein the 4Fe term includes ZVI, and the iron in the 2Fe₂O₃ term includes multivalent Fe(III).

When ZVI is converted to multivalent iron, the multivalent iron atoms may be charged. Some iron atoms may be negatively charged or positively charged, based on their respective valencies and the pH of the bulk solution. In some examples, sodium and chloride ions dissolved in the saline water may be attracted to the charged multivalent iron atoms on the surfaces of the nanoparticles 122 due to electrostatic forces between the ions and the multivalent iron atoms. In some instances, the sodium and chloride ions may become covalently bonded to each other and/or iron on the surface of the iron nanoparticles. Accordingly, the sodium and chloride ions in the saline water may be adsorbed onto the surfaces of the iron nanoparticles 122.

A mixture 124 of the saline water and the desalination media travel through a fluid circuit including an interior space of the first desalination tank 104-a. In various cases, the fluid circuit further includes the interior of a second desalination tank 104-b, a third desalination tank 104-c, and a fourth desalination tank 104-d. Each desalination tank, for instance, may have a volume in a range of 1 L to 10,000 L, such as 10 L, 50 L, 100 L, 200 L, 300 L, 400 L, 500 L, 600 L, 700 L, 800 L, 900 L, or 1,000 L. The first to fourth desalination tanks 104-a to 104-d are connected to one another in series, such that the mixture 124 travels through the first desalination tank 104-a, then the second desalination tank 104-b, then the third desalination tank 104-c, then the fourth desalination tank 104-d.

The first to fourth desalination tanks 104-a to 104-d each include baffles 126. The baffles 126 extend parallel to the first direction 112 within the interior of each of the first to fourth desalination tanks 104-a to 104-d. In various implementations, the baffles 126 extend from the lid 116 of the corresponding desalination tank among the first to fourth desalination tanks 104-a to 104-d and are spaced apart from the base 110 of the corresponding desalination tank. In some cases, the baffles 126 may be coupled to a floatation device that floats on the surface of the mixture 124 and extends in a direction opposite to the first direction 112 into the mixture 124. In some cases, at least some of the baffles 126 are configured to extend from the base 110 of the corresponding desalination tank among the first to fourth desalination tanks 104-a to 104-d and are spaced apart from the lid 116 and/or an upper surface of the mixture 124. Due to the spacings between the baffles 126 and the walls of the desalination tanks 104-a to 104-d, the fluid circuit within the interior of the desalination tanks 104-a to 104-d may have a winding path through the desalination system 100.

According to various implementations, the nanoparticles 122 within the mixture 124 are configured to capture one or more solutes within the mixture 124. In various implementations, ZVI (Fe(0)) in the nanoparticles 122 oxidizes within the mixture 124. As a result of the oxidation reaction, the solute(s) are bound to the nanoparticles 122. In various implementations, the solute(s) include one or more metals, such as at least one of copper, zinc, manganese, aluminum, selenium, or one or more radionuclides. In some cases, the solute(s) include dissolved ions, such as at least one of sodium, chloride, phosphate, sulfate, arsenic, nitrate, nitrite, or hypochlorite. In various implementations of the present disclosure, the nanoparticles 122 within the mixture 124 can be used to desalinate the mixture 124.

In particular cases, the solute(s) in their aqueous form are charged. For example, at least some of the solute(s) may have a positive charge. Examples of solutes having a positive charge include, for instance, sodium ions (Na+), copper ions (Cu2+), zinc ions (Zn2+), manganese ions (Mn2+), aluminum ions (Al3+), or arsenic ions (As5+). The iron oxide in the nanoparticles 122 has a negative charge. Accordingly, the positively charged solute(s) may electrostatically bind to the oxidized nanoparticles 122. Further, at least some of the solute(s) may have a negative charge. Examples of solutes having a negative charge include, for instance, chloride ions (CI-), selenium ions (Sn2-), phosphate ions (PO₄3-), sulfate ions (SO₄2-), nitrate ions (NO₃-), nitrite ions (NO—), or hypochlorite ions (ClO—). The negatively charged solute(s) may electrostatically bind to the positively charged solute(s) bound to the oxidized nanoparticles 122. Various other mechanisms for capturing solute(s) are also possible.

Experimentally, it was observed that a batch system, in which saline water was introduced to a ZVI nano media (i.e., a media that includes ZVI nanoparticles) and held in a static vessel, could result in a significant reduction of solute(s) in the water. However, such batch systems were limited by how much of the solute(s) could be captured. In addition, batch systems were observed to take weeks in order to achieve significant capture of the solute(s).

In various implementations of the present disclosure, solute(s) can be more quickly and efficiently removed from saline water by introducing a gas into the mixture 124. In various cases, the gas is introduced from a gas source 128 and through gas inlets 130 within the base 110 of each desalination tank among the desalination tanks 104-a to 104-d. The gas, for instance, propagates through the mixture 124 in the form of bubbles 132. The bubbles 132 travel through the mixture 124 in the first direction 112.

The gas in the bubbles 132, in various cases, includes an oxidizing gas that enhances the reaction from ZVI to iron(III) oxide. The gas, for example, includes oxygen and/or carbon monoxide. In some cases, the gas includes additional gases to prevent explosions, fires, and other risks when the desalination system 100 is operating. For instance, the gas may include nitrogen gas. In some examples, the gas includes air.

In at least a portion of the fluid circuit throughout the desalination system 100, the bubbles 132 move countercurrent to the desalination media within the mixture 124. For example, the nanoparticles 122 may travel in a direction that crosses and/or is opposite to the first direction 112 in at least a portion of the fluid circuit, while the bubbles 132 rise in the mixture 124 in the first direction 112. The baffles 126, in some cases, may cause the nanoparticles 122 and the mixture 124 to flow in a direction that opposes the first direction 112. In some examples, pumps and/or pipes (not illustrated) are included within the interior of the first to fourth desalination tanks 104-a to 104-d to cause the nanoparticles 122 from the desalination media to move countercurrent to the bubbles 132.

To minimize space within the fluid circuit in which the bubbles 132 are not present, in various cases, the gas inlets 130 are distributed throughout the major area of the base 110. In some cases, the gas inlets 130 are distributed at a substantially even density throughout the base 110. For example, a number of gas inlets 130 per square area at a center of the base 110 may be substantially equal to a number of gas inlets 130 per square area at an edge of the base 110. The distribution of gas inlets 130 may prevent spaces within the desalination tanks 104-a to 104-d in which the bubbles 132 do not traverse, thereby increasing the volume within the fluid circuit in which the oxidizing reaction of the nanoparticles 122 takes place.

The size of the gas inlets 130 and/or the bubbles 132 may impact the efficiency of the reaction within the desalination system 100. In some cases, an individual gas inlet among the gas inlets 130 (e.g., each gas inlet 130) has a width in a range of 0.001 meter (m) to 0.1 m, a range of 0.001 m to 0.01 m, or the like. In some cases, the number of gas inlets 130 within a single base 110 is in a range of 1 to 1,000,000, 10 to 1,000, or 10 to 100.

Experimentally, it was observed that the rate of the gas entering the desalination tanks 104-a to 104-d can greatly impact the efficiency of the desalination reaction. If the gas is introduced into the desalination tanks 104-a to 104-d at too low of a rate, the reaction may not be significantly sped up by the gas. However, if the gas is introduced into the desalination tanks 104-a to 104-d at too fast of a rate, then the reaction may occur so quickly that the solute(s) may be inefficiently bound to the iron oxide. Accordingly, in various implementations of the present disclosure, the gas is introduced into the mixture 124 at a rate in a range defined between a lower threshold and an upper threshold, such as in a range of 0.5 liter per minute (L/min) to 3 L/minute or in a range of 1 L/min to 2 L/min. For example, the gas may be introduced at a rate of 1 gram (g) per minute to 60 g/min, such as at a rate of 1.5 g/min to 20 g/min.

In various implementations of the present disclosure, the desalination system 100 is a flow-through system that provides greater desalination efficiency than a batch system. Once the mixture 124 traverses the fourth desalination tank 104-d, the mixture 124 flows into a settling tank 134. In some cases, the settling tank 134 lacks baffles 126. In various examples, the settling tank 134 substantially lacks bubbles 132. In some examples, the settling tank 134 is at least partially cone-shaped. When the mixture 132 is in the settling tank 134, the solute-laden nanoparticles 122 spontaneously sink to the bottom of the interior of the settling tank 134 in the form of waste media 136. In various cases, the waste media 136 is removed from the fluid circuit. In some cases, a valve at the base of the settling tank 134 selectively opens, thereby allowing the waste media 136 to drain from the settling tank 134. In some examples, a vacuum line is coupled to the base of the settling tank 134, which pulls the waste media 136 out of the settling tank 134. Once removed, the waste media 136 may be disposed of.

The remaining mixture 124 in the settling tank 134 flows into a filter 138. The filter 138, in various cases, further removes waste media 136 from the mixture 124. In various cases, the filter 138 is a physical filter that includes activated carbon. For instance, the filter 138 includes a housing (e.g., a polymer and/or metal housing) that encloses activated carbon particles. In various cases, a remaining portion of the nanoparticles 122 bound to the solute(s) is removed from the mixture by the filter 138. The filter 138, in various cases, releases treated water 140. The treated water 140, for instance, is effluent water discharged from the desalination system 100.

According to various implementations of the present disclosure, the desalination system 100 efficiently removes the solute(s) from the saline water. Experimentally, it has been shown that a similar system can remove at least 80% of dissolved sodium chloride from saline and/or brine in less than 10 hours (e.g., in a time range that is between 4 and 8 hours).

Although not specifically illustrated in FIG. 1, additional structures may be added to the desalination system 100. It has been observed that the temperature of the mixture 124 impacts the speed of the desalination process implemented by the desalination system 100. In some examples, the desalination system 100 includes one or more heaters (not illustrated) that increase a temperature of the mixture 124 above a lower threshold of 10, 15, 20, 25, or 30 degrees Celsius (C) (and below a boiling temperature). Various initial experiments indicate that the desalination rate increases significantly if the water is heated from 17° C. to 35° C. In some cases, a rate of the desalination (e.g., in terms of sodium and/or chloride removed from the water over time) may increase by 10 to 15% if the water is heated by 10° C. In some examples, one or more heaters are coupled to the water inlet 106 of the first desalination tank 104-a. In some cases, the desalination system 100 operates in an environment in which an ambient temperature is greater than 20, 25, or 30° C., such that the heater(s) may be unnecessary and/or deactivated.

In some implementations, the desalination system 100 includes one or more structures configured to control a pH of the mixture 124. It has been observed that the speed and efficiency of the desalination reaction between ZVI nano media and saline, for instance, can depend on the pH of the mixture 124. In some examples, the desalination media stored in the desalination media source 118 has a pH below 7. For instance, the desalination media may include phenols that make the slurry acidic. According to some examples, the desalination system 100 is configured to add a buffer, such as in the form of a buffer solution, to the mixture 124. The buffer may increase a pH of the mixture 124. For instance, the buffer may include bicarbonate. In some cases, the buffer is automatically dispensed through an inlet in one or more of the desalination vessels 104-a to 104-d.

According to various cases, fluids are propelled through the fluid circuit within the desalination system 100 via passive and/or active forces. In some examples, the desalination system 100 leverages hydrostatic pressure to propel the mixture 124 through the fluid circuit. For example, the saline water source 102 may store the saline at a higher altitude (with respect to gravity) than an outlet of the filter 138. In various cases, the water inlet 106 of the first desalination tank 104-a has a greater altitude than an outlet of the first desalination tank 104-a, such that the mixture 124 flows spontaneously through the first desalination tank 104-a. The inlets and outlets of the second to third desalination tanks 104-b to 104-d, for instance, may have similar relative altitudes. In some cases, the movement of fluids throughout the desalination system 100 are controlled through the fluid circuit via one or more pumps (not illustrated) and/or one or more valves (not illustrated).

In some examples, various components of the desalination system 100 are controlled by one or more processors (e.g., a controller, computing device, or the like). According to some examples, the processor(s) activate one or more of the components based on a predetermined schedule. For example, the processor(s) may cause a valve in the base of the settling tank 134 to open for a predetermined amount of time (e.g., ten minutes) at a predetermined frequency (e.g., every two hours).

In some cases, the processor(s) control the components of the desalination system 100 in response to conditions within the desalination system 100 and/or the saline water source 102. In some cases, one or more sensors (not illustrated) are disposed within the fluid circuit, communicatively coupled with the processor(s), and configured to detect at least one parameter of the desalination system 100. Examples of sensors include temperature sensors, salinity sensors, pH sensors, pressure sensors, light sensors, and the like. Examples of parameters detected by the sensors include, for instance, temperature, salinity, pH, pressure, light absorbance, light transmittance, and the like. The processor(s), for instance, may selectively activate components of the desalination system 100 based on one or more parameters detected by the sensor(s). According to various cases, the processor(s) may activate or deactivate an example component in response to detecting that a parameter is above a first threshold or below a second threshold.

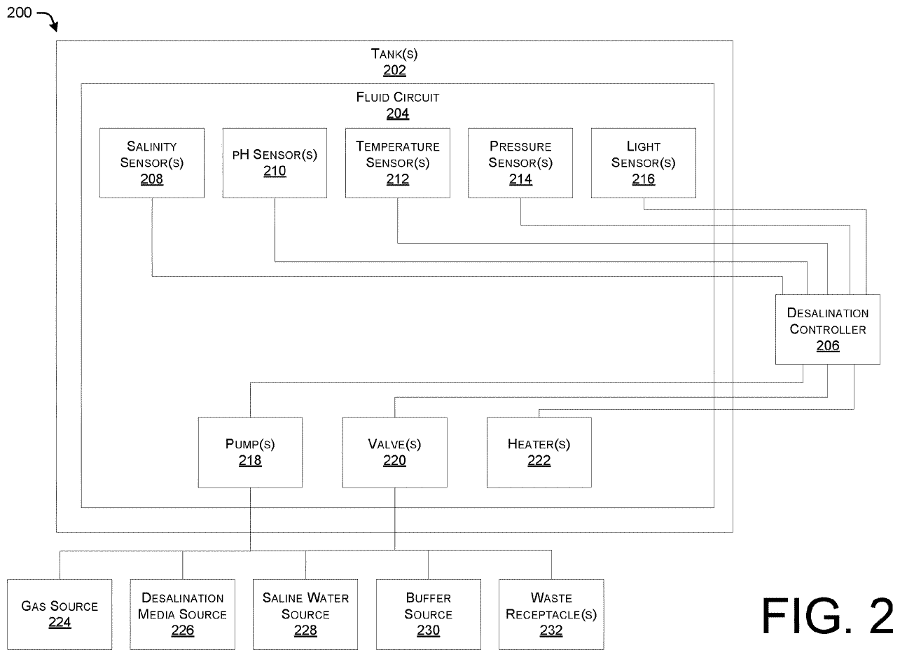

FIG. 2 illustrates an example environment 200 for controlling a desalination system, such as the desalination system 100 described above with reference to FIG. 1. The environment 200 includes one or more tanks 202 that accommodate a fluid circuit 204. For instance, the tank(s) 202 include the first desalination tank 104-a, the second desalination tank 104-b, the third desalination tank 104-c, the fourth desalination tank 104-d, the settling tank 134, the filter 138, or any combination thereof. The fluid circuit 204, in various cases, includes a hollow space that is disposed within the tank(s) 202. In some cases, the fluid circuit 204 includes one or more pipes, tubes, or other structures that connect multiple tanks among the tank(s) 202 together. A fluid, such as water (with or without dissolved solutes), a desalination media, a gas (e.g., air, oxygen, etc.), or any combination thereof, can be disposed in the fluid circuit 204. In some cases, the fluid flows through the fluid circuit 204. Although not specifically illustrated, in some cases, the fluid circuit 204 includes one or more inlets and/or one or more outlets.

In various implementations of the present disclosure, a desalination controller 206 is configured to analyze and/or cause modifications to conditions within the fluid circuit 204. In various cases, the desalination controller 206 is configured to optimize the conditions in the fluid circuit 204 to enhance efficient removal of one or more solutes from water disposed in the fluid circuit 204. The desalination controller 206 can be embodied in software and/or hardware. For example, the desalination controller 206 includes at least one computing device, such as a server computer, a laptop, a tablet computer, a smart phone, or other type of computer. In various cases, the desalination controller 206 includes one or more processors configured to execute instructions. The instructions, for instance, are stored in memory and/or non-transitory computer-readable media. By executing the instructions, the desalination controller 206 performs various functions described herein.

In some cases, the desalination controller 206 is located on the premises of the desalination system. For instance, the desalination controller 206 could be packaged with the tank(s) 202 of the desalination system. In some cases, the desalination controller 206 is located remotely from the premises of the desalination system. For instance, the desalination controller 206, in some cases, is implemented in at least one server computer located at least one kilometer (km) away from the tank(s) 202.

Various sensors may be communicatively coupled to the desalination controller 206. As used herein, endpoints are “communicatively coupled,” if they are connected to one another via at least one wired (e.g., electrical, optical, etc.) interface and/or at least one wireless interface (e.g., BLUETOOTH™, cellular, near-field communication (NFC), etc.) over which communication signals can be transmitted between the endpoints. These sensors, in various cases, are configured to detect one or more parameters of the fluid circuit 204. These parameters include at least one of salinity, pH, temperature, pressure, light transmittance, or light reflectance, for example.

At least one salinity sensor 208, for instance, is disposed within the fluid circuit 204. The salinity sensor(s) 208 is configured to detect a salinity level of water in one or more locations within the fluid circuit 204. Examples of the salinity sensor(s) 208 include, for instance, an electrical sensor configured to detect an electrical conductivity of the fluid in the fluid circuit 204. In various cases, the salinity sensor(s) 208 includes an anode and a cathode that are suspended in the fluid, as well as a power source that applies a voltage across the anode and the cathode. In some examples, the salinity sensor(s) 208 detects the electrical conductivity of the fluid by detecting an electrical current between the anode and the cathode. Alternatively, the salinity sensor(s) 208 includes a current source that outputs a current across the anode and the cathode, and then a voltage detector that detects the voltage between the anode and the cathode in order to detect the electrical conductivity of the fluid. In various implementations, the electrical conductivity is proportional to an amount of dissolved solute(s) in the fluid.

At least one pH sensor 210 is disposed in the fluid circuit 204, for example. The pH sensor(s) 210 is configured to detect a pH of the fluid at one or more positions in the fluid circuit 204. In some cases, the pH sensor(s) 210 include a pH electrode bulb including a membrane (e.g., including glass) that is permeable to H+ions in the fluid. The pH sensor(s) 210 may further include a reference cell that contains a pH neutral electrolyte solution. An electrical sensor is connected to the pH electrode bulb and the reference cell and is configured to detect a voltage between the pH electrode bulb and the reference cell. If H+ions in the fluid enter the pH electrode bulb, then a voltage is detected by the electrical sensor. The magnitude of the voltage, for instance, is dependent on an amount of H+ions in the fluid, and is therefore indicative of the acidity of the fluid.

At least one temperature sensor 212 may be disposed in the fluid circuit 204. The temperature sensor(s) 212 is configured to detect the temperature of the fluid circuit 204 at one or more positions within the fluid circuit 204. Various types of temperature sensors can be utilized in the environment 200. According to various implementations, the temperature sensor(s) 212 include one or more thermocouples, thermistors, Peltier elements, or any combination thereof. In various examples, the temperature sensor(s) 212 is configured to output an electrical signal indicative of one or more detected temperatures by the temperature sensor(s) 212.

In some cases, one or more pressure sensor(s) 214 are disposed in the fluid circuit 204. The pressure sensor(s) 214 is configured to detect a pressure at one or more positions within the fluid circuit 204. In some cases, the pressure sensor(s) 214 include one or more capacitive and/or piezoelectric pressure sensors. For example, the pressure sensor(s) 214 include a membrane disposed between a space with a reference pressure and a space within the fluid circuit 204. When the pressure in the space within the fluid circuit 204 is different than the reference pressure, the membrane is configured to deform. In various implementations, the pressure sensor(s) 214 detects the pressure in the space based on an amount of deformation of the membrane. For instance, the capacitance of a capacitor including the membrane as a plate, or an electrical signal output by the membrane (e.g., due to the piezoelectric effect), is indicative of the deformation of the membrane and the pressure in the space.

According to some examples, one or more light sensors 216 are disposed in the fluid circuit 204. In some cases, the light sensor(s) 216 include one or more light sources (e.g., light-emitting diodes (LEDs)) and one or more light detectors (e.g., photodiodes, phototransistors, etc.) configured to detect light emitted by the light source(s). In some cases, the fluid in the fluid circuit 204 is physically disposed between the light source(s) and the light detector(s). An amount of light detected by the light detector(s), for example, is dependent on an amount of the light that is transmitted (e.g., not absorbed) by the fluid in the fluid circuit 204. In some examples, the light detector(s) is configured to detect an amount of light that is both emitted by the light source(s) and reflected by the fluid in the fluid circuit 204. In some cases, a frequency of the light emitted by the light source(s) and detected by the light detector(s) is optimized for absorbance and/or reflectance of a particular material (e.g., oxidized iron nanoparticles) in the fluid disposed in the fluid circuit 204. For example, the absorbance of the light of an aqueous solution of the oxidized nanoparticles at a predetermined concentration may be greater than a predetermined threshold. In various cases, the light detector(s) output an electrical signal indicative of an amount of light absorbed and/or reflected by the fluid in the fluid circuit 204. This signal may be indicative of an amount of the material present in the fluid in the fluid circuit 204.

The desalination controller 206, in various cases, receives signals from the salinity sensor(s) 208, the pH sensor(s) 210, the temperature sensor(s) 212, the pressure sensor(s) 214, the light sensor(s) 216, or any combination thereof, that are indicative of parameters detected by the respective sensors. In some cases, the signals include one or more analog signals, and the desalination controller 206 includes one or more analog-to-digital converters (ADCs) configured to convert the signals into digital signals indicative of the detected parameters. In some cases, the signals output by the sensors include digital signals that are indicative of the detected parameters. In various cases, the desalination controller 206 is configured to analyze data (e.g., in the form of digital signals) indicative of the detected parameters.

In various implementations, the desalination controller 206 is communicatively coupled to one or more active elements that are configured to change conditions within the fluid circuit 204. The desalination controller 206, for instance, is configured to output one or more signals (also referred to as “control signals”) to the active elements in order to cause changes to conditions within the fluid circuit 204.

In various cases, one or more pumps 218 are present in the fluid circuit 204. The pump(s) 218, in various cases, are configured to control pressure differentials between different subspaces in the fluid circuit 204, thereby inducing fluid flow within the fluid circuit 204. The pump(s) 218, for instance, include at least one peristaltic pump, at least one centrifugal pump, at least one diaphragm pump, at least one magnetic pump, or any combination thereof. In some cases, the pump(s) 218 can include one or more propellers configured to cause fluid movement within the fluid circuit 204.

According to some implementations, one or more valves 220 are present in the fluid circuit 204. The valve(s) 220, for instance, are configured to selectively open or close portions of the fluid circuit 204 to fluid flow. In various cases, the valve(s) 220 include check valves, ball valves, butterfly valves, or any combination thereof. Notably, the valve(s) 220 may include at least one valve configured to control liquid (e.g., saline and/or desalination media slurry) flow in the fluid circuit 204 and/or to control gas (e.g., air) flow in the fluid circuit 204.

In various cases, one or more heaters 222 are present in the fluid circuit. The heater(s) 222, for instance, are configured to heat portions of the fluid circuit 204. In some cases, the heater(s) 222 include one or more resistive elements that output heat when a voltage is applied. In some cases, the heater(s) 222 include one or more Peltier elements.

In some examples, the pump(s) 218 and/or valve(s) 220 are configured to control the flow of fluid between the fluid circuit 204 and one or more external spaces (e.g., receptacles). These external spaces may include a gas source 224 (e.g., the gas source 128), a desalination media source 226 (e.g., the desalination media source 118), a saline water source 228 (e.g., the saline water source 102), a buffer source 230, and one or more waste receptacles 232. In various cases, the gas source 224 is a space that contains a gas (e.g., air and/or oxygen). The desalination media source 226, for instance, is a space that contains desalination media (e.g., nano media slurry). In some examples, the saline water source 228 includes saline water that is to be desalinated by the desalination system. In various cases, the buffer source 230 is a space that includes a buffer solution (e.g., a bicarbonate solution) that can be used to adjust the pH within the fluid circuit 204. In various examples, the waste receptacle(s) 232 includes a space that is configured to receive waste media and/or captured solute(s) from the fluid in the fluid circuit 204. These external spaces, for instance, include one or more tanks, tubs, or other containers that are fluidly and selectively coupled to the fluid circuit 204.

In various implementations of the present disclosure, the desalination controller 206 is configured to control the pump(s) 218, the valve(s) 220, the heater(s) 222, or any combination thereof, based on one or more parameters detected by the salinity sensor(s) 208, the pH sensor(s) 210, the temperature sensor(s) 212, the pressure sensor(s) 214, the light sensor(s) 216, or any combination thereof. For example, the desalination controller 206 may output a control signal that activates or deactivates the pump(s) 218, the valve(s) 220, the heater(s) 222, or any combination thereof, in response to determining that one or more parameters are above a first threshold and/or below a second threshold.

In particular cases, the desalination controller 206 controls the pump(s) 218 and/or the valve(s) 220 in response to detecting that a salinity detected by the salinity sensor(s) 208 is above a threshold. In some examples, the desalination controller 206 causes the pump(s) 218 to recirculate fluid in the fluid circuit 204 until the salinity is below the threshold. In some examples, the desalination controller 206 causes the valve(s) 220 to block the fluid from being discharged (e.g., into a filter, such as the filter 138, or into a settling tank, such as the settling tank 134) until the salinity is above the threshold. In some cases, the desalination controller 206 causes the pump(s) 218 and/or valve(s) 220 to release desalination media from the desalination media source 226 in response to detecting that the salinity is above the threshold. In some examples, the desalination controller 206 causes the pump(s) 218 and/or valve(s) 220 to release saline water from the saline water source 228 into the fluid circuit 204 in response to detecting that the salinity is below the threshold.

According to some cases, the desalination controller 206 controls conditions within the fluid circuit 204 based on a pH detected by the pH sensor(s) 210. In some examples, the desalination media has a relatively low pH (e.g., due to the presence of phenols added to the desalination media during iron nanoparticle synthesis). It has been observed that the efficiency and speed by which the desalination media removes solute(s) from saline can be enhanced by lowering the pH of the saline added to the fluid circuit 204. In some examples, the desalination controller 206 causes the pump(s) 218 and/or valve(s) 220 to release buffer (e.g., water containing bicarbonate or some other type of basic solution) from the buffer source 230 into the fluid circuit 204 in response to detecting that the pH detected by the pH sensor(s) 210 is below a threshold.

In some examples, the desalination controller 206 adjusts conditions within the fluid circuit 204 based on a temperature detected by the temperature sensor(s) 212. In various implementations, it has been observed that the efficiency and speed by which the desalination media removes solute(s) from saline can be enhanced by controlling the temperature of the fluid in the fluid circuit 204 to be in a range of 25° C. to 50° C. In various cases, the desalination controller 206 causes the heater(s) 222 to activate in response to determining that a temperature detected by the temperature sensor(s) 222 is below a threshold.

In various instances, the desalination controller 206 adjusts the conditions within the fluid circuit 204 based on a pressure detected by the pressure sensor(s) 214. A pressure differential between different locations along the fluid circuit 204 may be indicative of an amount of fluid flow in the fluid circuit 204. In some cases, an initial phase of flow through the fluid circuit 204 is achieved via hydrostatic flow from the saline water source 228 into the fluid circuit 204, wherein the saline water source 228 may be elevated with respect to the fluid circuit 204. However, after a sufficient amount of saline water has left the saline water source 228, in some cases, pressure in the fluid circuit 204 may equilibrate, causing limited to nonexistent fluid flow. In some examples, the desalination controller 206 activates the pump(s) 218 to activate in response to determining that a difference between a pressure detected at a first part of the fluid circuit 204 and a pressure detected at a second part of the fluid circuit 204 is below a threshold.

According to some cases, the desalination controller 206 may cause the valve(s) 220 to selectively vent gasses in the fluid circuit 204 to an environment outside of the fluid circuit 204. For instance, if the fluid circuit 204 is sealed from an external environment, and the gas source 224 releases gas into the fluid circuit 204, the pressure within the fluid circuit 204 may build to an undesirable level. In various cases, the desalination controller 206 causes the valve(s) 220 to vent fluid in the fluid circuit 204 to the external environment in response to detecting that a pressure detected by the pressure sensor(s) 214 is above a threshold.

In some examples, the desalination controller 206 selectively causes removal of waste media and/or solute from fluid in the fluid circuit 204. In particular examples, iron nanoparticles capture solute from the fluid during oxidation. The oxidation of iron nanoparticles in the fluid, in various cases, changes the absorbance and/or reflectance of the fluid. For instance, oxidized nanoparticles can cause treated water to appear opaque and/or as an orange color. In various cases, the desalination controller 206 causes the pump(s) 218 and/or valve(s) 220 to release waste media and solute from the fluid circuit 204 and into the waste receptacle(s) 232 in response to determining that a light absorbance and/or reflectance of the fluid in the fluid circuit 204 exceeds a first threshold and/or that a light transmittance of the fluid in the fluid circuit 204 is below a second threshold. The desalination controller 206, in various implementations, determines the light absorbance, reflectance, or transmittance based on signals output by the light sensor(s) 216.

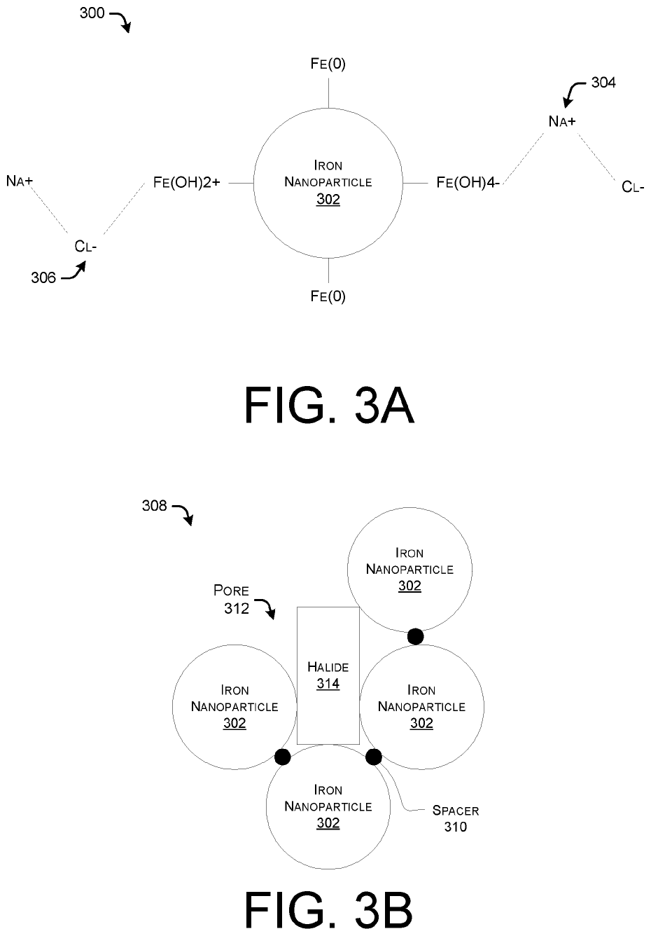

FIGS. 3A and 3B illustrate examples of iron nanoparticles configured to adsorb sodium (Na) and chlorine (Cl) atoms. FIG. 3A illustrates an example environment 300 in which an iron nanoparticle 302 captures a sodium ion (Na+) 304 and a chlorine ion (Cl−) 306. Although FIGS. 3A and 3B are described with reference to removing sodium and chlorine ions, it should be understood that in some cases, other positive and negative ions can be removed from water using similar techniques.

The iron nanoparticle 302 may include ZVI (Fe(0). According to various implementations, the iron nanoparticle 302 may have a mean particle size that is less than 1000 nm. For instance, the mean particle size can be calculated by observing a sample of iron nanoparticles under a microscope, measuring lengths of the iron nanoparticles in at least one direction, and then calculating an arithmetic mean of the lengths. For instance, an AMSCOPE 3.5×-180× Light Emitting Diode (LED) Zoom Digital Stereo Microscope with a 10 MP camera could be used to capture an image of the particles (e.g., in or out of solution). Image processing software can be used to perform point counting (e.g., software provided by National scientific and Technical Research Council, Buenos Aries, Argentina). The point counting software may also be used to identify the diameters of the particles.

In some cases, a length (e.g., a diameter) of the iron nanoparticle 302 may be between 10 and 100 nm, 20 to 80 nm, or 35 to 55 nm. In various implementations, the iron nanoparticle 302 may have a surface area between about 0.1 square meters per gram (m2/g) to about 25 m2 /g. As used herein, the term “about” can refer to a range of numbers that would be rounded to the number specified. For instance, the term “about 0.1” may refer to a range of 0.05⁻ to 0.14⁻.

In some cases, when the iron nanoparticle 302 begins to corrode (i.e., oxidize), iron on the surfaces of the particles is hydrolyzed, and hydroxyl (—OH) groups are formed on the surfaces of the particles. The hydroxyl groups on the surfaces are amphoteric, and can have a negative charge or a positive charge depending on a pH of the solution.

According to some implementations, at least some of the ZVI on the surface of the iron nanoparticle 302 can be oxidized while immersed in water. When the ZVI becomes oxidized, two types of complexes may be formed: FeOOH2+ and FeOOH—. The positively charged FeOOH2+ may electrostatically attract the negatively charged Cl− 306 dissolved in the water. The negatively charged FeOOH-may electrostatically attract the positively charged Na+ 304 dissolved in the water. The electrostatic attraction between the charged complexes and the Cl− 306 and Na+ 304 ions may cause a first layer of Cl− 306 and Na+ 304 ions to be adsorbed onto the surface of the iron nanoparticle 302.

Once a first layer of Na+ 304 and Cl− 306 is adsorbed onto the surface of the iron nanoparticle 302, additional ions may be further adsorbed onto the first layer. For instance, additional negatively charged Cl− ions 306 may be electrostatically attracted to the positively charged Na+304 in the first layer, and additional positively charged Na+ 304 may be electrostatically attracted to the negatively charged Cl− 306 in the first layer. Multiple layers of Cl− 306 and Na+ 304 may assemble on the surface of the iron nanoparticle 302. In some cases, the Cl− 306 and Na+ 304 may form a crystal structure.

The adsorption of the Na+ 304 and Cl−306 due to electrostatic forces with oxidized forms of iron in the nanoparticle 302 may occur relatively quickly. As Cl− 306 is attracted to, and attaches to, Fe(OH)4+functional groups on the surface of the iron nanoparticle 302, a subsequent, slower reaction may take place that also causes desalination. In some examples, the Cl− 306 may further catalyze the oxidation of Fe(0) in the iron nanoparticle 302. Additional Cl− 306 may diffuse through the surface layer of the iron nanoparticle 302 and cause further oxidation of the Fe(0) below the outer surface of the iron nanoparticle 302 and within the interior of the iron nanoparticle 302. Additional layers of Fe—O—Cl and Fe—O—Na may be generated within the interior of the iron nanoparticle 302.

Both reactions (the surface adsorption and capture by iron within the interior of the iron nanoparticle 302) may cause water uptake. In addition, when the iron nanoparticle 302 is submerged in water, the salinity gradient may increase as a distance to the iron nanoparticle 302 decreases, due to the capture of the Na+304 and the Cl− 306. Accordingly, an a nano media including iron nanoparticles 302 may aggregate into solid particles that expand in size, due to water uptake and osmosis, when exposed to saline.

FIG. 3B illustrates an example environment 308 of multiple iron nanoparticles 302 capturing Na and Cl dissolved in water. The multiple iron nanoparticles 302 may be packed together. In some cases, spacers 310 may be disposed between the iron nanoparticles 302. Some examples of spacers 310 include a starch (e.g., potato starch), carboxy methyl cellulose, polyvinyl pyrrolidine, or the like. The spacers 310 may prevent the iron nanoparticles 302 from agglomerating. Although not illustrated, in some cases, at least some of the iron nanoparticles 302 may be directly touching each other.

In various implementations, a pore 312 can be present between the iron nanoparticles 302. In some cases, multiple pores 312 can be present between groups of the iron nanoparticles 302. The pore 312 may be generated based on the geometries of the iron nanoparticles 302 and the spacers 314. In various examples, the pore 312 may have a width of 20-100 nm.

When the iron nanoparticles 302 are exposed to water in which chlorine and sodium atoms are dissolved, the sodium and chlorine atoms may be adsorbed onto the surfaces of the iron nanoparticles 302. In some cases, the sodium and chlorine atoms may assemble into a halide 314 disposed within the pore 312. The halide 314 may be a crystal including the sodium and chlorine atoms.

In various implementations, the iron nanoparticles 302 can remove a significant amount of salt from water. For example, in the case of Na and Cl removal from water, a ratio of a weight or mass of Na and Cl removed from saline water by the iron nanoparticles 302 to a weight or mass of iron in the iron nanoparticles 302 (i.e., NaCl:Fe) can be as much as 20:1.

In some cases, additional contaminants can be removed from the water by the iron nanoparticles 302. For example, various other solutes described herein can also be captured by the iron nanoparticles 302.

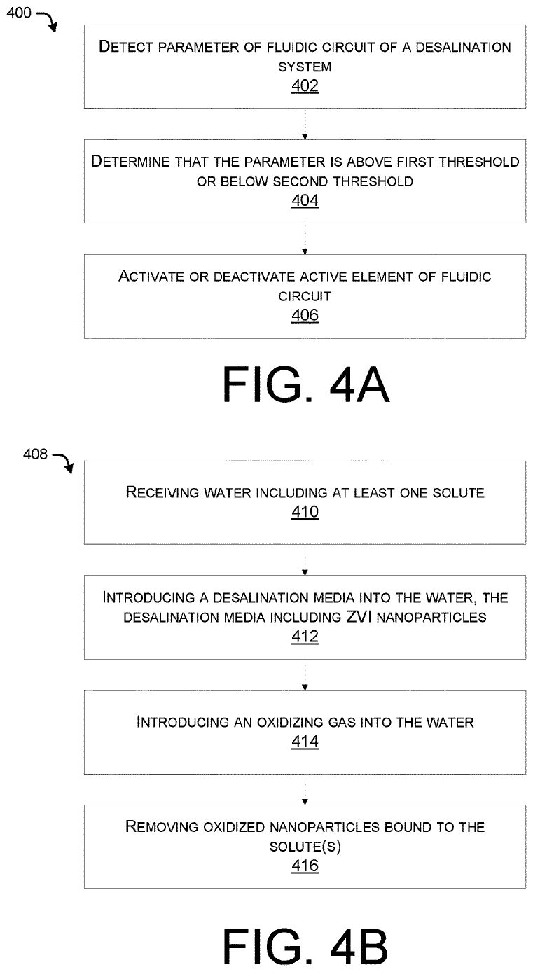

FIG. 4A illustrates an example process 400 for dynamically controlling a desalination system. The process 400 may be performed by an entity including one or more elements of the desalination system 100 and/or the environment 200 described above. In various cases, the process 400 can enhance the efficiency and/or performance of the desalination system.

At 402, the entity detects a parameter of a fluid circuit of a desalination system. In various cases, the entity includes a sensor disposed inside of the fluid circuit that detects the parameter. The parameter, in various cases, may be a characteristic of water disposed inside of the fluid circuit. Examples of the parameter include salinity, pH, temperature, light absorbance, light transmittance, or pressure.

At 404, the entity determines that the parameter is above a first threshold and/or below a second threshold. In some cases, the first threshold is greater than the second threshold. In some examples, the first threshold is less than the threshold.

At 406, the entity activates or deactivates an active element of the fluid circuit. For instance, the entity may activate at least one pump, at least one valve, at least one heater, or any combination thereof. In some cases, the entity may deactivate at least one pump, at least one valve, at least one heater, or any combination thereof.

FIG. 4B illustrates an example process 408 for removing at least one solute from water. The process 500 may be performed by an entity including one or more elements of the desalination system 100 and/or the environment 200 described above.

At 410, the entity receives water including the solute(s). In various cases, the at least one solute includes one or more metals. Examples of metals, for instance, include copper, zinc, manganese, aluminum, selenium, a radionuclide, or any combination thereof. In some examples, the solute(s) include sodium and/or chloride, such as in the form of aqueous ions. In some examples, the solute(s) include phosphate, sulfate, arsenic, nitrate, chlorine, calcium, potassium, or any combination thereof. The water, for instance, can include seawater, mining waste, industrial waste, agricultural waste, or any combination thereof.

At 412, the entity introduces a desalination media into the water, the desalination media including ZVI nanoparticles. In various cases, the desalination media further includes one or more phenols. For instance, the desalination media is acidic and has a pH that is less than 7. In various cases, the desalination media is a slurry of the ZVI nanoparticles.

At 414, the entity introduces an oxidizing gas into the water. According to various examples, the entity introduces an oxygen-containing gas into the water. For instance, the gas includes air. In various examples, the gas is bubbled into the water. For example, the gas is released through one or more valves in a base and/or sidewall of a tank in which the water is disposed. According to various cases, the oxidizing gas (e.g., air, oxygen, etc.) is released at a rate in a range of 1 L per minute to 2 L per minute. For instance, the oxidizing gas may be at a pressure in a range of 10 kilopascals (kPa) to 14 kPa. In some examples, the oxidizing gas is released at a rate in a range of 1.5 grams (g) per minute to 15 g per minute. In some cases, the oxidizing gas is introduced into a volume of water that is between 10 L and 500 L, such as a volume that is between 100 and 200 L.

In various cases, the ZVI nanoparticles in the desalination media capture the solute(s) during an oxidation process. In various cases, the solute(s) adsorb and/or are bound to the ZVI nanoparticles as the ZVI nanoparticles are oxidized. In some cases, the solute(s) form halite crystals that are disposed between the ZVI nanoparticles.

At 416, the entity removes oxidized nanoparticles bound to the solute(s). For example, the entity includes a settling tank that causes the oxidized nanoparticles to collect in a sludge. The sludge, for instance, can be removed from the settling tank by opening a valve at the base of the settling tank.

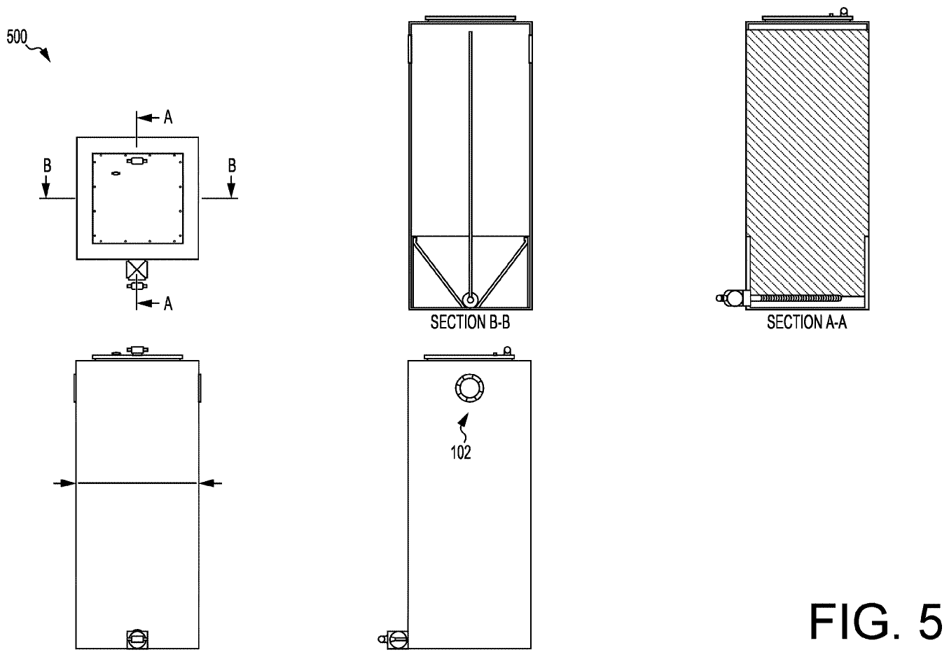

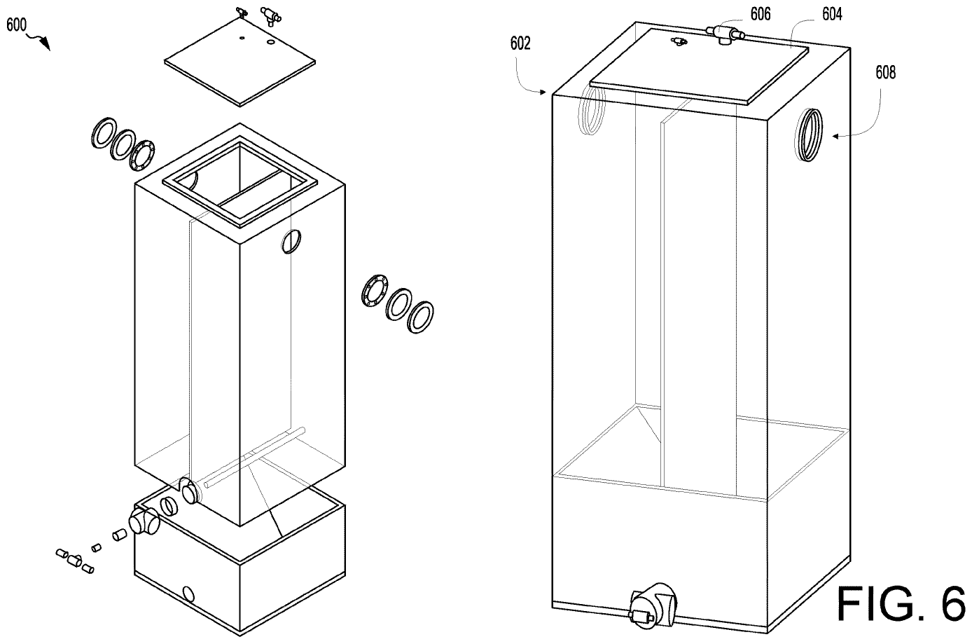

FIG. 5 illustrates an example of a desalination tank 500. FIG. 6 illustrates exploded and interior views of an example desalination tank 600 in accordance with various implementations of the present disclosure.

In various implementations of desalination systems disclosed herein, the desalination tank 600 can be utilized to desalinate saline water. The saline water includes dissolved salts, such as dissolved sodium and chloride ions. In some cases, saline water may include additional components, such as other ions, contaminants, and particles. In various implementations, the desalination tank 600 can be used to remove other types of contaminants from water. For example, the desalination tank 600 may be used to remove dissolved components from water that is not saline water.

In the illustrated desalination vessel 100, saline water may enter through an inflow port 602 (also referred to as an “inlet”). Any pipe through which saline water can flow may be suitable for bringing the saline water to the inflow port 602. For instance, the pipe may include at least one of a metal (e.g., steel, copper, etc.) pipe, a plastic (e.g., silicone, Polyvinyl Chloride (PVC), butadiene, etc.) tube, or their equivalents. In some cases, the pipe may include a material that is resistant to degradation by saline water.

The saline water may flow through the inflow port 602 into the desalination tank 600. A pipe (not illustrated) carrying the saline water may be sealed onto the inflow port 602. For instance, a compressible o-ring (including, e.g., silicone, butadiene, or the like) may be compressed between the pipe and the desalination tank 600. In some cases, the pipe may be chemically bonded or heat-bonded to the desalination tank 600.

In various implementations, the desalination tank 600 may include a solid housing configured to hold fluid (e.g., water). According to some example implementations, the housing may be equipped with a removable component, through which the interior of the desalination tank 600 may be accessed. For instance, as shown in FIG. 6, the housing may have a removable lid 604.

According to implementations of the present disclosure, iron may be introduced into the desalination tank 600. In some implementations, the iron may be in the form of iron nanoparticles.

The iron nanoparticles may be introduced into the desalination tank 600 as a slurry. For example, the slurry may be fed into the desalination tank 600 via a slurry influent line coupled to a slurry port 606 (also referred to as a media inlet). In some cases, the iron nanoparticles may covalently bond, or otherwise stick to one another, wherein pores may be present between the iron nanoparticles. In some cases, the sodium and chloride ions (or another type of dissolved salts in the saline water) may assemble into a cubic crystal structure within the pores. For instance, the sodium and chloride may assemble into halite crystals within the pores.

By capturing the sodium, chloride, and/or other ions in association with the iron nanoparticles, the desalination tank 600 may be used to extract sodium, chloride, and/or other ions from the saline water, thereby generating desalinated water. In various implementations, the desalinated water may flow out of the desalination tank 600 through an outflow port 608. Any pipe through which water can flow may be coupled with the outflow port 608. For instance, an outflow pipe coupled with the outflow port 608 may include at least one of a metal (e.g., steel, copper, etc.) pipe, a plastic (e.g., silicone, PVC, butadiene, etc.) tube, or their equivalents. The outflow pipe may be sealed onto an outlet port 608 of the desalination tank 600. For instance, a compressible o-ring (including, e.g., silicone, butadiene, or the like) may be compressed between the outflow pipe and the desalination tank 600. In some cases, the outflow pipe may be chemically bonded or heat-bonded to the desalination tank 600.

Although implementations of the desalination tank 600 described with reference to FIG. 6 indicate that water is actively flowing through the desalination tank 600, implementations are not so limited. The iron nanoparticles in the desalination tank 600 may actively capture sodium and chloride ions in saline water that is statically held inside of the desalination tank 600. For instance, various sodium and chloride ions may move (e.g., via Brownian motion) through static (e.g., non-flowing) saline water. When the sodium and chloride ions encounter surfaces of the iron nanoparticles in the desalination tank 600, the sodium and chloride ions can become adsorbed onto the surfaces of the surfaces of the iron nanoparticles. Thus, the saline water may become gradually desalinated even when it is held statically in contact with the desalination tank 600 via diffusion.

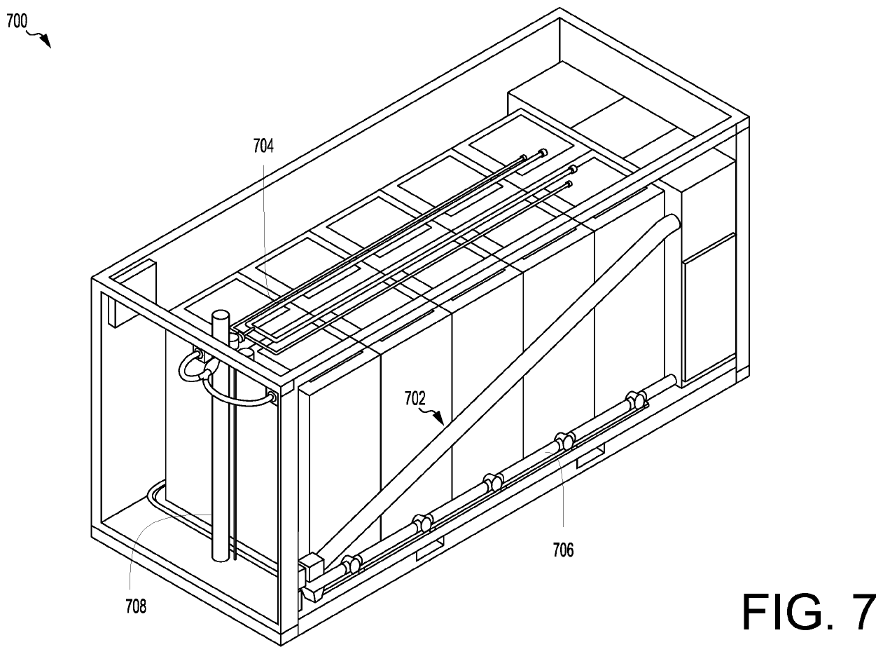

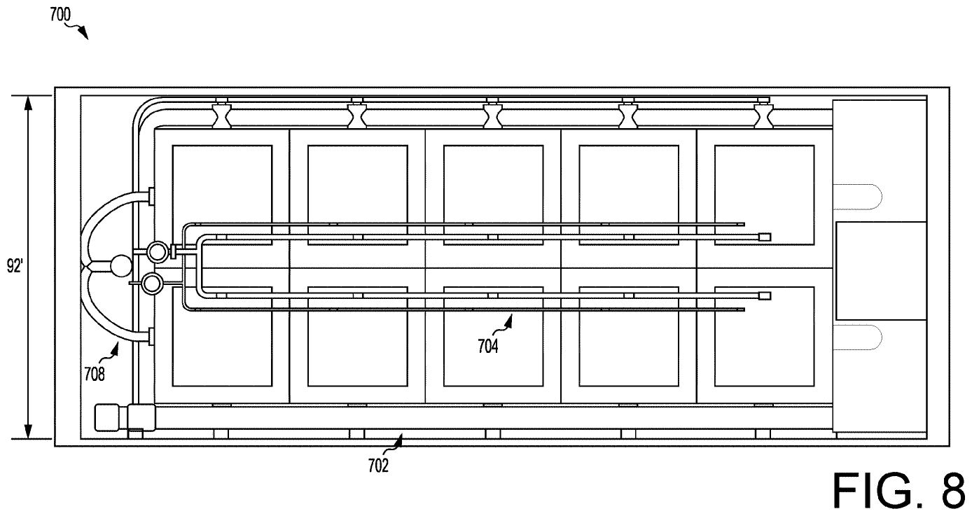

FIG. 7 illustrates a first view of an example desalination system 700 including multiple example desalination tanks. FIG. 8 illustrates a second view of the example desalination system 700 including multiple desalination tanks.

For example, the desalination system 700 may include ten desalination tanks (e.g., ten instances of the desalination tank 600) connected in series and/or parallel. In various cases, the desalination system 700 includes two fluid circuits, each including five desalination tanks connected to one another in series. The two fluid circuits may be connected to one another in parallel. In various cases, each fluid circuit includes a settling tank connected to the last desalination tank in the series. A recycling pipe 702 selectively connects the settling tank to the first desalination tank in the series. For instance, a valve may be coupled to, or included in, the recycling pipe 702 that selectively enables water to be cycled through the fluid circuit. In some cases, the valve opens if a salinity of the water in the settling tank exceeds a threshold.

Multiple slurry pipes 704 are configured to output desalination media into the respective desalination tanks of the desalination system 700. Further, an air pipe 706 is configured to output air into a base of each of the desalination tanks in the desalination system 700. Saline water enters each fluid circuit of the desalination system 700, for instance, via an inflow pipe system 708. The inflow pipe system 708, for instance, splits into to two pipes that are respectively coupled to inlets of the first desalination tanks in each fluid circuit.

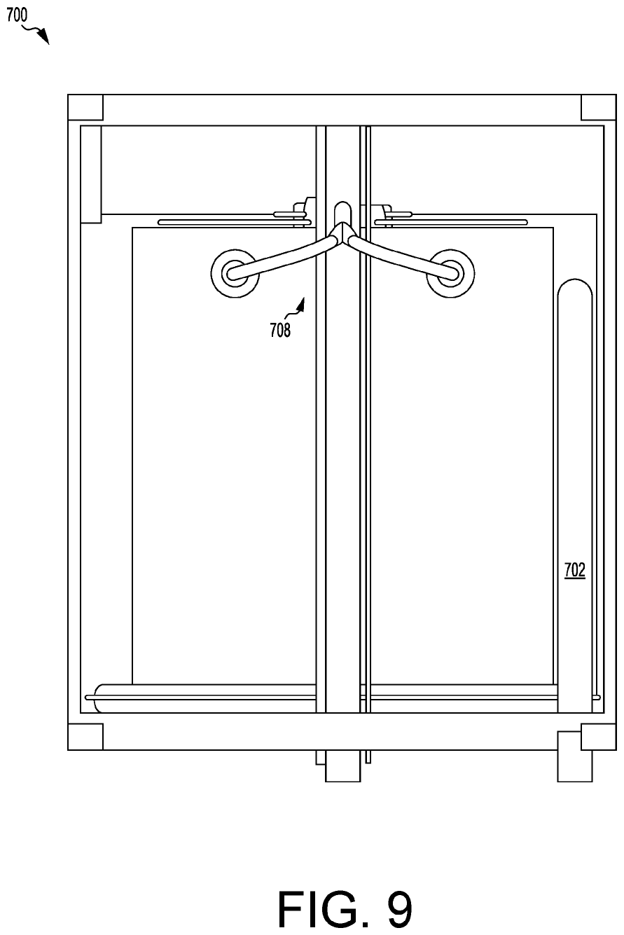

FIG. 9 illustrates a front view of the desalination system 700. Specifically, FIG. 9 illustrates a pair of desalination tanks that can be arranged in a side-by-side fashion in the example desalination system 700. For example, the pair of desalination tanks may represent the two first desalination tanks in the desalination system 700.

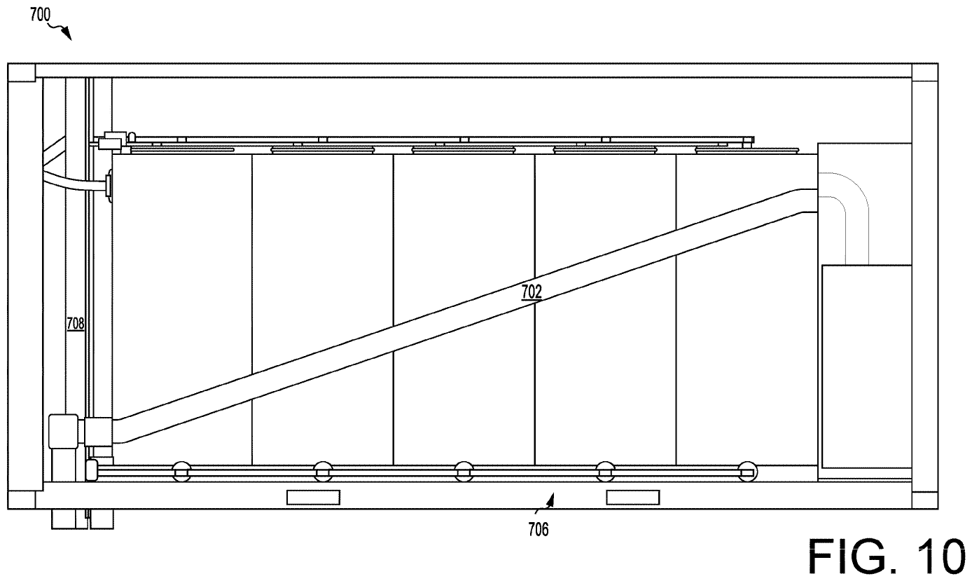

FIG. 10 illustrates a side view of the example desalination system 700 including multiple desalination tanks.

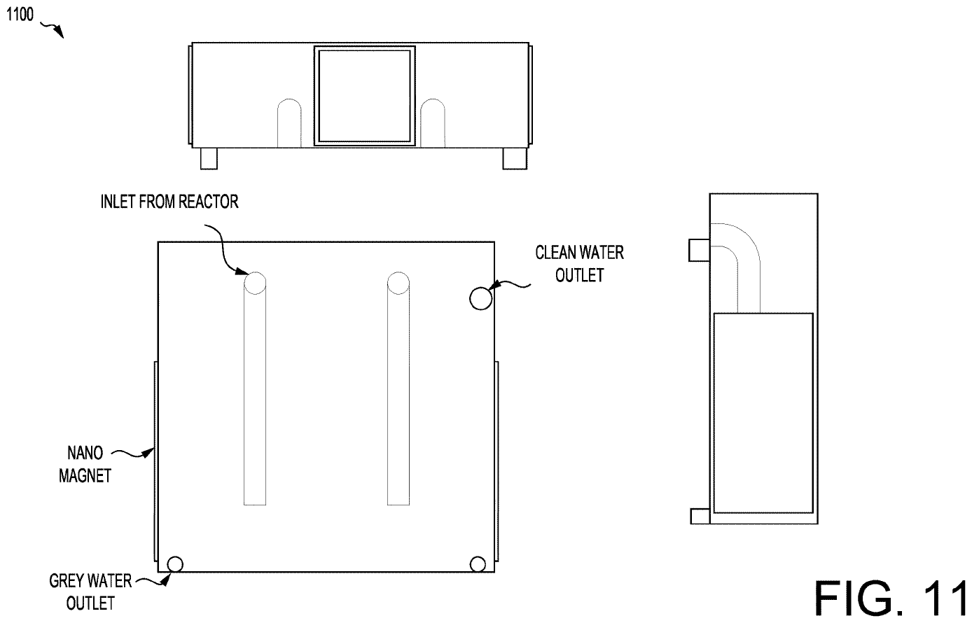

FIG. 11 illustrates various views of a settling tank 1100 of an example desalination system, such as the desalination system 700. The settling tank 1100, for instance, may be the final tank in a fluid circuit including a series of multiple desalination tanks. In some cases, the settling tank 1100 includes a magnet configured to capture iron-based desalination media. In some cases, water output from the settling tank 1100 is optionally filtered before being output from the desalination system.

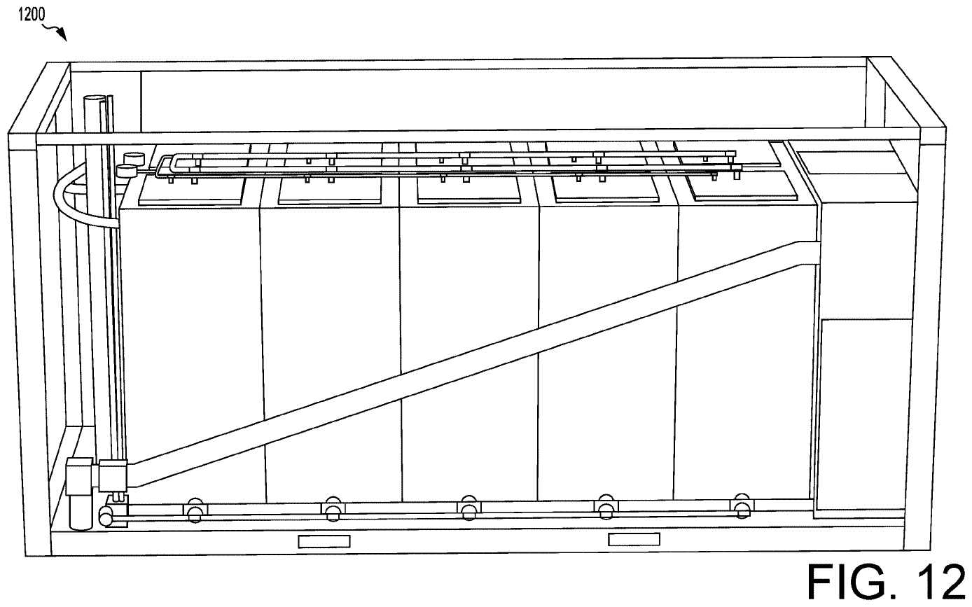

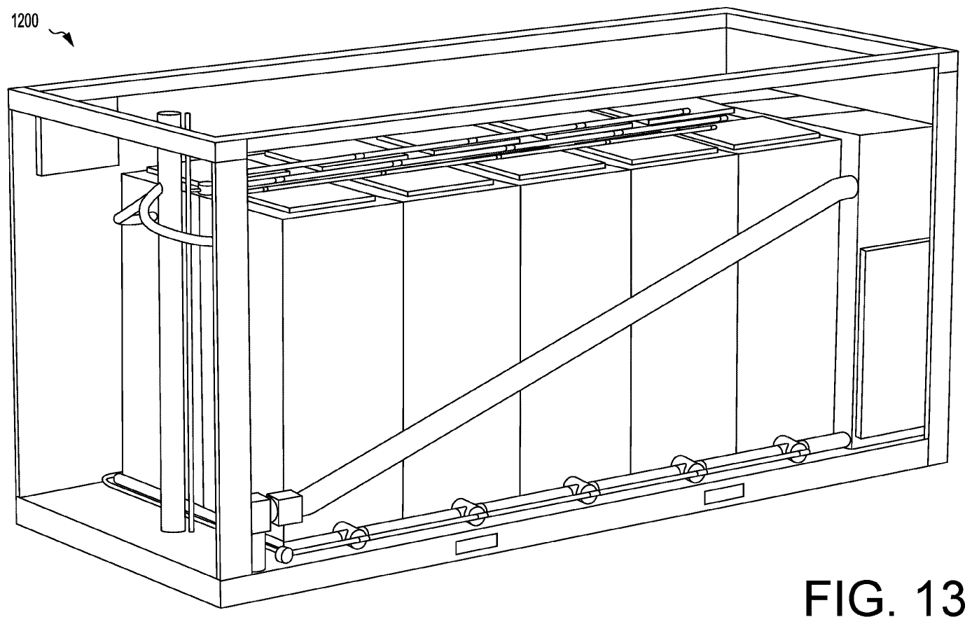

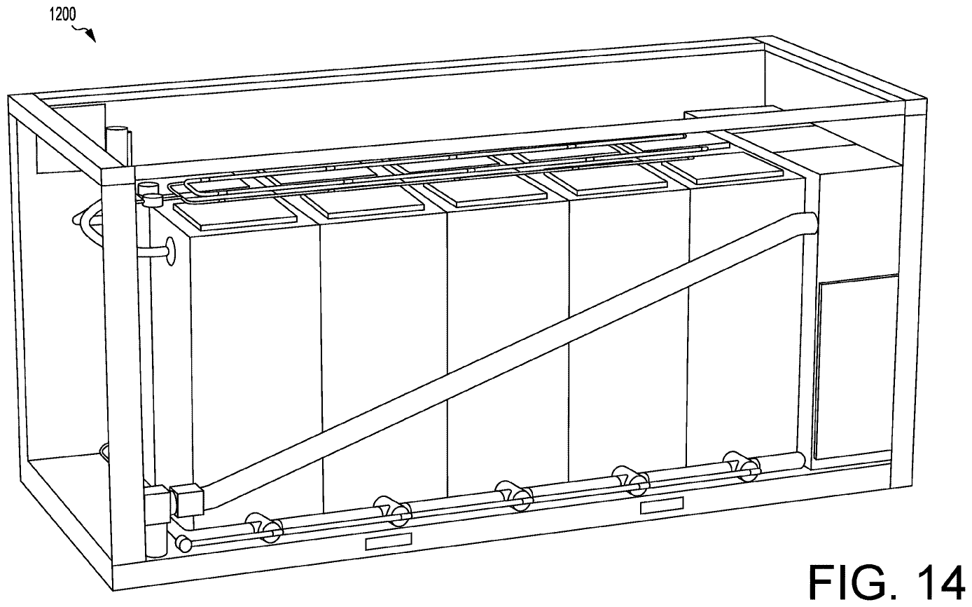

FIGS. 12 to 14 illustrate a modular desalination system 1200 packaged into a housing. FIG. 12 illustrates a schematic of the modular desalination system 1200 including multiple desalination tanks at a first view. FIG. 13 illustrates a schematic of the modular desalination system 1200 including multiple desalination tanks at a second view. FIG. 14 illustrates a schematic of the modular desalination system 1200 including multiple desalination tanks at a third view. In various cases, the housing of the modular desalination system 1200 is a rectangular prism. For example, the housing could be shipping container suitable for efficient transport on a train, truck, boat, or the like.

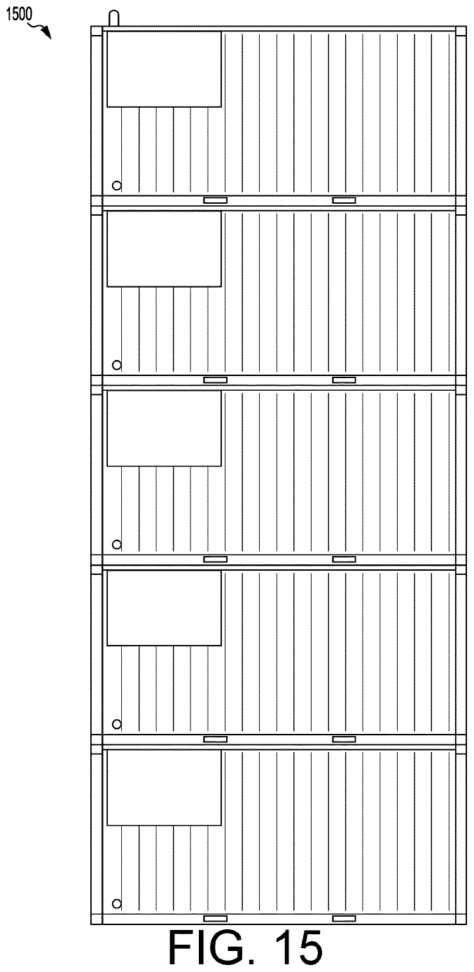

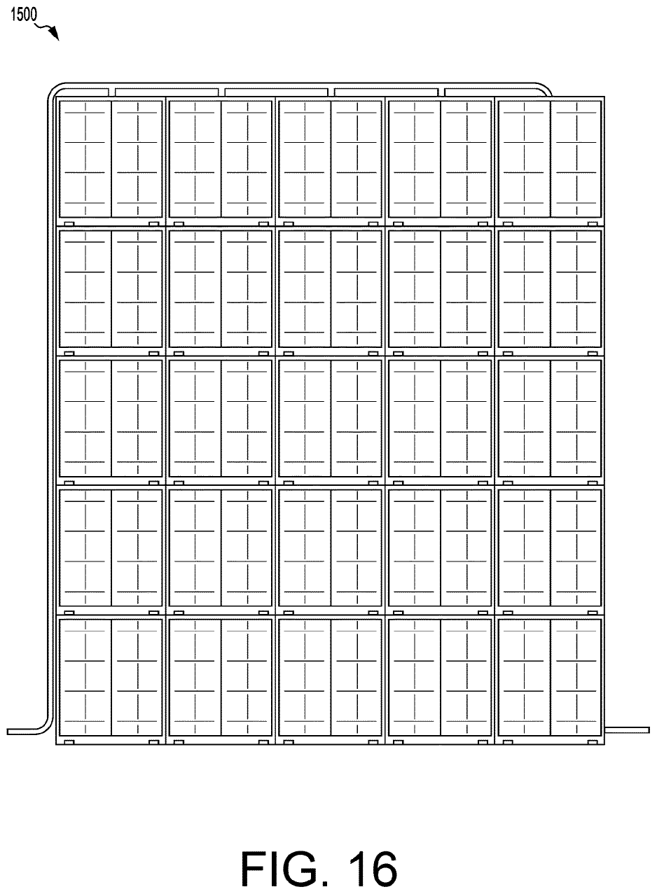

FIG. 15 illustrates an example of a multiple desalination systems 1500 housed in shipping containers and stacked from a first view. FIG. 16 illustrates an example of the multiple desalination systems 1500 housed in shipping containers and stacked from a second view.

In some examples, a desalination system including the desalination tanks 2102 may be designed to fit within a shipping container (e.g., boxcar), as depicted in FIGS. 12-16, for instance. In this example, a shipping container may contain one or more desalination tanks. In the example depicted in FIGS. 12-14, the shipping container includes ten desalination tanks. The shipping container may also contain other equipment associated with the iron based desalination process, such as inflow or outflow piping, iron addition equipment, air addition equipment, control and/or sensor equipment, power supply, etc. Note that FIGS. 15 and 16 depict example of desalination tank arrangements that include stacked desalination tanks and/or systems. In some implementations, outflow from one desalination tank or group of desalination tanks may be directed downward to the underlying desalination tank or group of desalination tanks of the stack. For instance, one shipping container containing a desalination system may be stacked on top of another shipping container that also contains a desalination system. Such a configuration may help to lower the need for pumping between desalination tanks. FIG. 16 depicts a system that includes twenty-five shipping containers arranged in a stack. The arrangement shown in FIG. 16 is not meant to be limiting; a wide variety of arrangements of shipping containers and/or desalination tanks is contemplated. In some examples, one element of an arrangement may be reserved for control equipment, or other equipment associated with a desalination system. For instance, considering the example depicted in FIG. 16, one of the shipping containers may contain control equipment, an iron feed tank, air feed equipment, pumps, or other equipment associated with the desalination system, and may not contain a desalination tank.

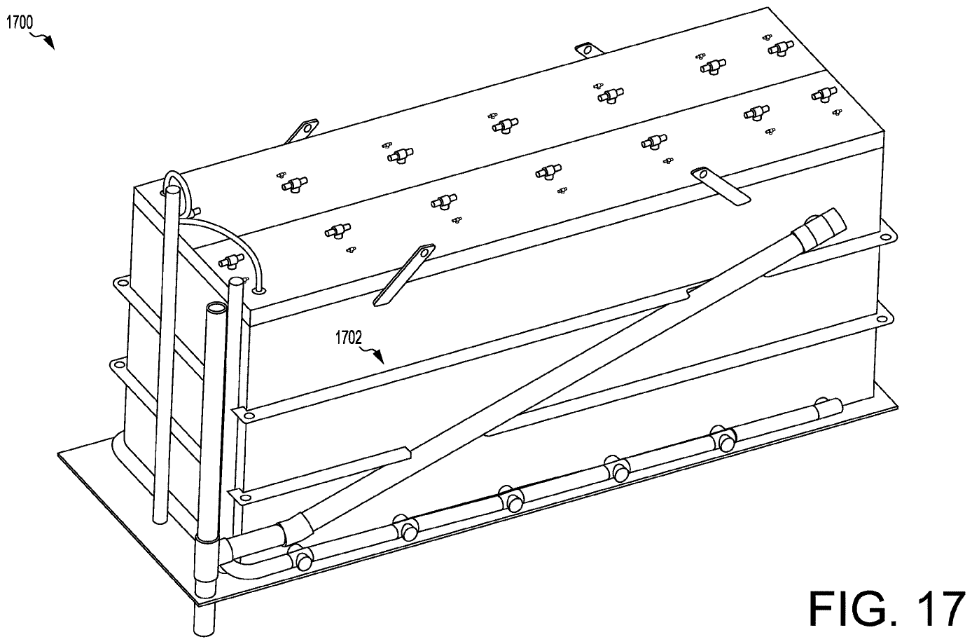

FIG. 17 illustrates an example group of desalination tanks 1700 that can be included in a modular desalination system. The desalination tanks 1700 are provided with supports 1702 configured to maintain the shape an stability of the desalination tanks 1700 when the desalination tanks 1700 are filled with water being desalinated and/or included in a modular desalination system that is vertically stacked.

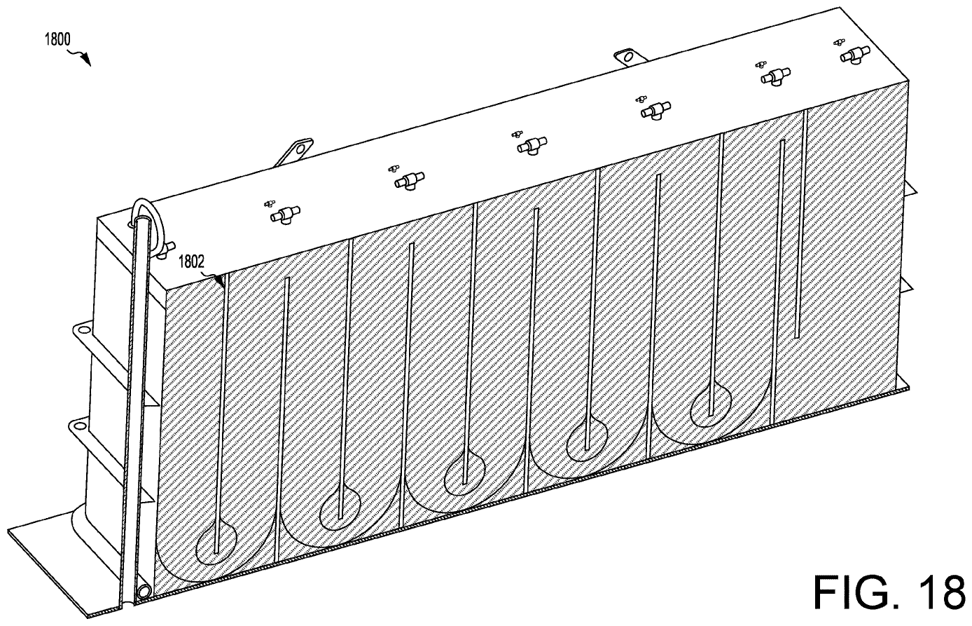

FIG. 18 illustrates a first cross-sectional view of a group of desalination tanks 1800 that can be included in a desalination system. For example, a fluid circuit including the desalination tanks 1800 linked together in series are illustrated. The cross-sectional view illustrated in FIG. 18 shows that each of the desalination tanks 1800 includes a vertical baffle 1802 that extends from a top surface of the respective tank. Due to the presence of the baffle 1802, water entering the desalination tank 1800 through its inlet flows in a downward direction toward the base of the desalination tank 1800. At the base, for instance, air can be introduced into the water. Then, the water flows in an upward direction in order to reach the outlet of the tank.

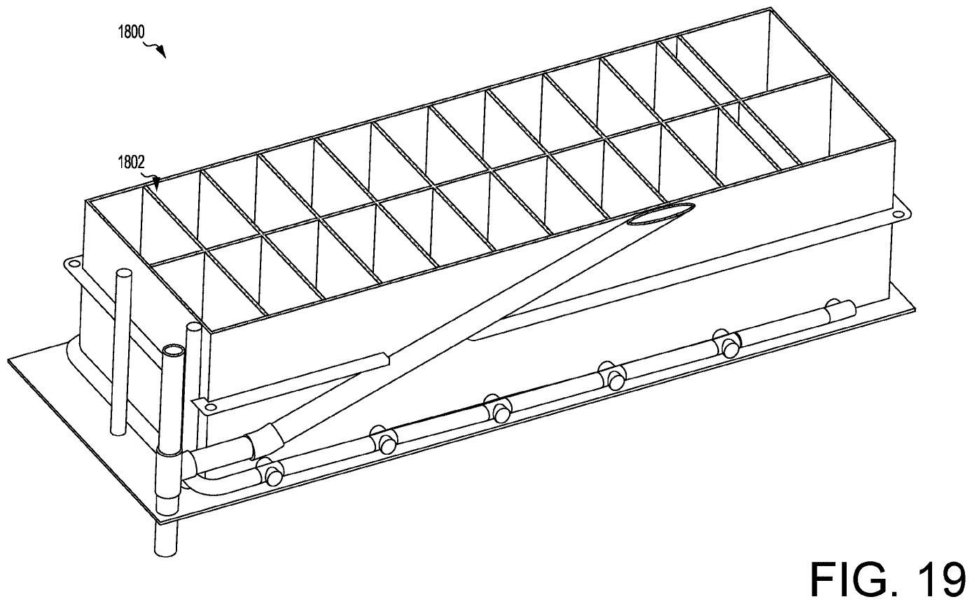

FIG. 19 illustrates a second cross-sectional view of the group of desalination tanks 1800 that can be included in the desalination system. As shown in FIG. 19, the baffle 1802 of each desalination tank 1800 bisects the interior space of the desalination tank 1800.

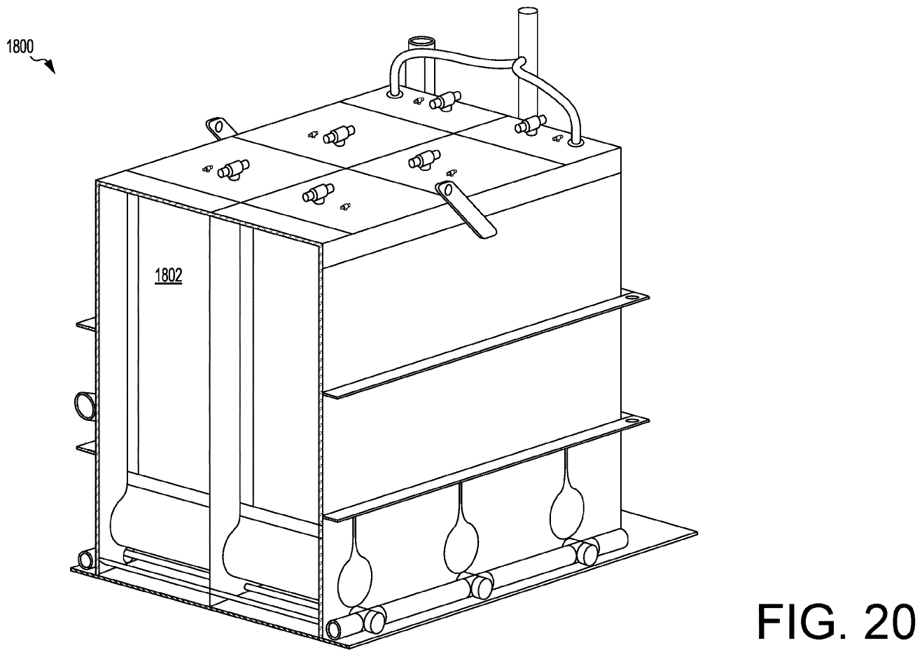

FIG. 20 illustrates a third cross-sectional view of the group of desalination tanks 1800 that can be included in the desalination system. As shown in FIG. 20, the baffle 1802 extends from a top surface of each desalination tank 1800. A space exists between the lower end of the baffle 1802 and the base of the desalination tank 1800. Notably, in this example, the lower end of the baffle 1802 is rounded. In some cases, the rounded profile of the lower end of the baffle 1802 enhances laminar flow of water (and air) within the desalination tank 1800.

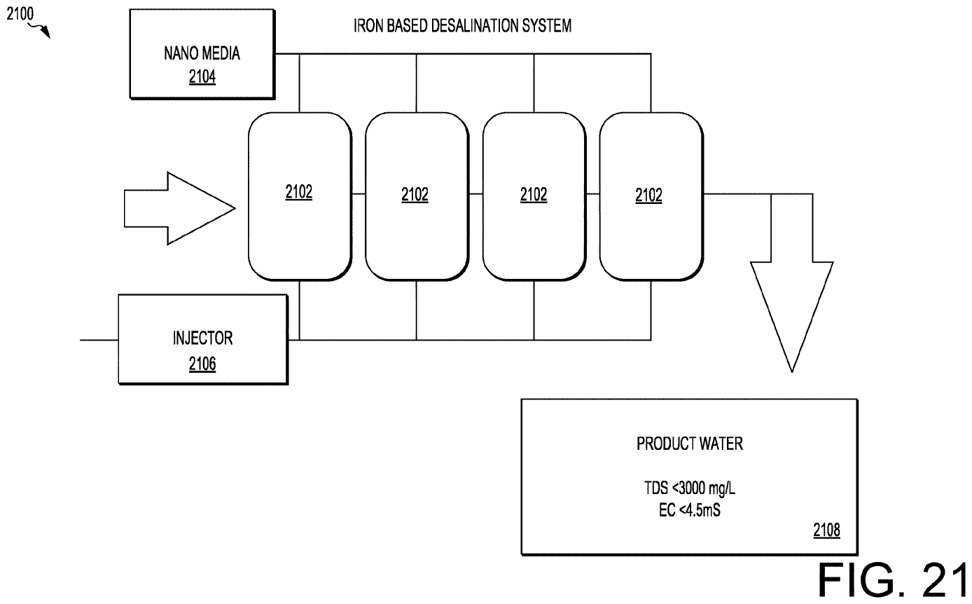

FIG. 21 illustrates an example schematic of a desalination system 2100 that utilizes nano media and compressed air to desalinate water. The desalination system 2100, for instance, includes multiple desalination tanks 2102 connected to one another in series. In various implementations, the desalination system 2100 can be used to desalinate industrial runoff, mining wastewater, seawater, or the like. In some cases, the desalination system 2300 can be used to reduce TDS levels in saline water below acceptable levels (e.g., as defined by the US EPA) for disposal into the ground, for agricultural uses, for drinking water, or the like. As illustrated in FIG. 21, water may progress from the left side of the drawing page toward the right side. The water may flow passively (e.g., via gravity) and/or actively (e.g., via the actions of one or more pumps).

In various implementations, saline water may flow into the system 2100. The saline water may first pass through a first desalination tank 2102. The first desalination tank 2102 may have one or more inlets and/or one or more outlets. For instance, the desalination tank 2102 may receive the saline water by an inlet and may release the saline water by an outlet. The desalination tank 2102 may have any suitable shape for temporarily storing the saline water. For instance, the desalination tank 2102 may be cylindrical, spherical, prismatic, or the like. The desalination tank 2102 may have one or more walls in contact with the saline water. The walls may include, for instance, a material resistance to degradation by the saline water, such as plastic (e.g., cross-linked polyethylene, fiberglass reinforced plastic, etc.), metal (e.g., steel), or the like.

Water may flow through a portion of a fluid circuit into one or more desalination tank 2102s (e.g., the desalination tank 104-a, the desalination tank 600, or any combination thereof). The fluid circuit may include, for example, at least one of pipes, tubes, any vessel through which fluid can flow, or the like. In some cases, the water can flow via hydrostatic pressure. For instance, a saline water tank may be positioned at a higher elevation than the desalination tank(s) 2102, thereby generating a hydrostatic pressure. Gravity may propel the saline water from the saline water tank to the desalination tank(s) 2102, in various implementations. Accordingly, in some cases, the water can passively flow into the desalination tank(s) 2102 from the saline water tank.

In some cases, multiple desalination tanks 2102 can be connected to each other in series. For instance, an outflow pipe of one desalination tank 2102 may be connected to an inflow port of another desalination tank 2102, such that water flowing through the desalination tanks 2102 may be desalinated by both desalination tanks 2102. When multiple desalination tanks 2102 are connected to each other in series, a greater amount of sodium and chloride can be extracted from water in a single pass through the system, as compared to treatment using a single one of the desalination tanks 2102. In some examples, multiple desalination tanks 2102 can be connected to each other in parallel. For instance, an inflow pipe of one desalination tank 2102 may be connected to an inflow pipe of another desalination tank 2102, such that water flowing through the desalination tanks 2102 may be split between the two (or more) desalination tanks 2102. When multiple desalination tanks 2102 are connected to each other in parallel, an overall flow rate through the desalination tanks 2102 may increase.

In various implementations, a portion of the fluid circuit extending between the saline water tank and the desalination tank(s) 2102 may include an inflow valve. The inflow valve may include any of various types of valves. For instance, the inflow valve may include at least one of a ball valve, a butterfly valve, a choke valve, a diaphragm valve, a gate valve, a globe valve, a knife valve, a needle valve, a pinch valve, a plug valve, a solenoid valve, a spool valve, or the like.

In some cases, the inflow valve may be connected in series between the saline water tank and the desalination tank(s) 2102. In various implementations, the inflow valve may selectively allow or prevent the passage of water from the saline water tank to the desalination tank(s) 2102. For instance, when the inflow valve is in an “open” position, the water may flow from a saline water tank (not illustrated) to the desalination tank(s) 2102 through the inflow valve. When the inflow valve is in a “closed” position, the inflow valve may prevent the flow of water from the saline water tank to the desalination tank(s) 2102 through the inflow valve. In some cases, the inflow valve may limit or otherwise control the flow of water between the saline water tank and the desalination tank(s) 2102. For example, when the inflow valve is partially opened, the inflow valve may limit the flow of water from the saline water tank to the desalination tank(s) 2102.

In various examples, nano media 2104 is introduced into one or more of the desalination tanks 2102. For example, the nano media 2104 is introduced as a slurry that is provided through one or more pipes that are coupled with inlets on the top surfaces of the desalination tanks 2102. The nano media 2104, for instance, includes water and ZVI nanoparticles. When introduced to the saline water in the desalination tanks 2102, the ZVI nanoparticles may capture sodium, chloride, and other solutes within the saline.

In various implementations, the portion of the fluid circuit extending between the saline water tank and the desalination tank(s) 2102 may include an injector 2106, which may inject an oxidation agent into the water flowing between the saline water tank and the desalination tank(s) 2102. As used herein, the term “oxidation agent,” and its equivalents, can refer to a substance that initiates or otherwise facilitates oxidation of a chemical species. In various implementations, the oxidation agent may cause, or exacerbate, oxidation of the ZVI in the nano media 2104 that has been introduced into the desalination tank(s) 2102. The oxidation agent may be in a solid form, a liquid form, an aqueous form, or a gaseous form. Some examples of the oxidation agent include at least one of oxygen (O₂), ozone (O₃), hydrogen peroxide (H₂O₂), any other electron acceptor that does not introduce additional contamination (e.g., that would increase TDS) into the saline water, or the like. The injector 2106 may include any device configured to input the oxidation agent into the fluid circuit (e.g., into saline water present in the fluid circuit). For instance, the injector 2106 may be a fluid injector, a gas injector, or a liquid injector. In some cases, the injector 2106 includes an air compressor or source of compressed air (e.g., a tank that holds compressed air).

Although not illustrated, in some cases, the injector 2106 may inject a reducing agent (e.g., CO) into the water in order to control one or more chemical reactions performed in the desalination tank(s) 2102. For instance, if iron in the desalination tank 2102(s) becomes clogged with halite, it might be advantageous to reduce the iron to unclog the desalination tank 2102(s).

In some cases, the injector 2106 can be selectively controlled by an external controller (not illustrated), which activate the injector 2106 in response to identifying that one or more conditions are present. For example, the external controller could cause the injector 2106 to deliver the oxidation agent to water in the fluid circuit in response to receiving a user input requesting the delivery of the oxidation agent.

The water may flow into the desalination tank(s) 2102, and the desalination tank(s) 2102 may at least partially desalinate the water. When sodium and chloride ions dissolved in the water contact the iron nanoparticles in the nano media 2104, the ions may become attached to the iron nanoparticles. Accordingly, the sodium and chloride ions may be retained on the desalination tank(s) 2102, and the salinity of the water may be reduced.

In various implementations, the desalination system 2300 can further include a heater (not illustrated) that provides heat to the water in the fluid circuit. The heater can provide heat to the desalination tank(s) 2102, however, in some examples, the heater may provide heat to a component of the fluid circuit that is upstream of the desalination tank(s) 2102 (e.g., between the saline water tank and the desalination tank(s) 2102). In some implementations, the heat provided by the heater may increase the temperature of the water flowing through the desalination tank(s) 2102, which may increase the adsorption rate of the sodium and chloride ions on the iron nanoparticles. Various initial experiments indicate that the desalination rate increases significantly if the water is heated from 17° C. to 35° C. In some cases, a rate of the desalination (e.g., in terms of sodium and/or chloride removed from the water over time) may increase by 10 to 15% if the water is heated by 10° C. In various implementations, the heater could include an electrically resistive material configured to emit heat when electric current runs through the resistive material. In some examples, the heater could include a Peltier element. In some instances, the heater could be a conduction heater, a convection heater, a heat pump, an immersion heater (e.g., a tank of heated fluid), a circulation heater, or the like. Any heater known in the art could be utilized as the heater.

Product water 2108 that has been desalinated by the desalination tank(s) 2102 may flow out from the desalination tank(s) 2102. In various implementations, the product water 2108 flowing out of the desalination tank(s) 2102 may have a lower concentration of sodium and chloride ions (and/or other solutes) than the water flowing into the desalination tank(s) 2102.

A system including the desalination tank(s) 2102 optionally includes a recycle pump (not illustrated). The recycle pump may be configured to pump water from an outflow port of a desalination tank 2102 and/or a settling tank to the upstream side of the desalination tank 2102, and/or to another desalination tank 2102 for further treatment. The recycle pump can be, for instance, at least one of a positive displacement pump, an impulse pump, a velocity pump, a steam pump, a valveless pump, or the like.

In some cases, water output from a desalination tank 2102 may be recycled back into the same or another desalination tank 2102. For instance, in a recycle mode, an outflow valve may be closed and the recycle pump may be activated, thereby causing the recycled water to flow to an inflow port of a desalination tank 2102. An outflow valve can include any of various types of valves. For instance, the outflow valve may include at least one of a ball valve, a butterfly valve, a choke valve, a diaphragm valve, a gate valve, a globe valve, a knife valve, a needle valve, a pinch valve, a plug valve, a solenoid valve, a spool valve, or the like.

The recycled water may cycle through the desalination tank(s) 2102 multiple times and/or for an extended period of time. Accordingly, the desalination tank(s) 2102 may further decrease the amount of solute in the recycled water due to additional opportunities for sodium and chloride adsorption by the iron-based desalination filter(s) in the desalination tank 2102(s).

In some implementations, a salinity sensor (not illustrated), or some other component in communication with a salinity sensor, may be configured to activate a flow-through mode and/or the recycle mode of the system. The salinity sensor may include, or may be coupled to, one or more processors configured to execute instructions stored on memory. When executing the instructions as the system is in the flow-through mode, the processor(s) may compare the measured salinity (or electrical current) to a predetermined threshold. In some cases, the threshold may correspond to a predetermined maximum salinity, such as a maximum salinity required for agricultural applications (e.g., 1,200 mg/L) and/or drinking water (e.g., 500 mg/L). If the measured salinity exceeds the maximum salinity, the processor(s) may cause the outflow valve to close, thereby activating the recycle mode. In some cases, the processor(s) may further activate the pump in the recycle mode. In some cases, the processor(s) may further open one or more recycle valve(s) in the fluid circuit in the recycle mode. The recycle valve(s) can include any of various types of valves. For instance, the recycle valve(s) may include at least one of a ball valve, a butterfly valve, a choke valve, a diaphragm valve, a gate valve, a globe valve, a knife valve, a needle valve, a pinch valve, a plug valve, a solenoid valve, a spool valve, or the like. When the recycle valve(s) are open, the recycle pump may pump the recycled water from an outflow of a desalination tank 2102 to an inflow port of the same or another desalination tank 2102. The processor(s) may further monitor the salinity measured by the salinity sensor in the recycle mode.

If the measured salinity is lower than a threshold, the processor(s) may cause the outflow valve to open, thereby activating the flow-through mode. The threshold used to activate the flow-through mode may be the same or different as the threshold used to activate the recycle mode. For instance, the threshold used to activate the flow-through mode may be 50-500 mg/L less than the threshold used to activate the recycle mode. In some cases, the processor(s) may further deactivate the recycle pump in the flow-through mode. The processor(s) may further cause at least one of the recycle valve(s) to close in the flow-through mode. In various implementations, the processor(s) may open or close the outflow valve, activate or deactivate the recycle pump, or the like, by transmitting one or more control signals to the recycle pump and/or the outflow valve. Accordingly, the salinity of the water desalinated by the desalination tank 2102(s) can be controlled automatically. In some implementations, the water desalinated by the desalination tank(s) 2102 and output from the outflow valve can be output from the system as desalinated water.

Although not required, in various implementations, the system may further include an RO system. The RO system may be configured to further desalinate water treated by the desalination tank(s) 2102. The RO system can include any reverse osmosis system known in the art. In some cases, the RO system may include a physical filter that captures insoluble particles in the water. The water output from the outflow valve may be received on a first side of a water-permeable membrane. An RO pump (or some other pump within the RO system) may impose a pressure on the water received from the desalination tank(s) 2102 (e.g., the water from the outflow valve). The RO pump can be, for instance, at least one of a positive displacement pump, an impulse pump, a velocity pump, a steam pump, a valveless pump, or the like. Due to the pressure, substantially pure water may be output through the water-permeable membrane to a second side of the water-permeable membrane. In some cases, the substantially pure water can be output from the RO system as desalinated water. In various implementations, saline water retained on the first side of the membrane of the RO system can be recycled through the fluid circuit. For instance, one or more RO valves may be opened and the RO pump may reverse direction, such that saline water byproduct from the RO system may be output in the fluid circuit as recycled water, and may be recycled through the desalination tank 2102(s) for further desalination. Thus, unlike other RO systems, the system may refrain from producing highly saline water as a byproduct. The RO valve(s) can include any of various types of valves. For instance, the RO valve(s) may include at least one of a ball valve, a butterfly valve, a choke valve, a diaphragm valve, a gate valve, a globe valve, a knife valve, a needle valve, a pinch valve, a plug valve, a solenoid valve, a spool valve, or the like.

In some examples, a desalination tank 2102, or the system including the desalination tanks 2102, may include a filter to filter out particulate matter in water flowing through the desalination tank 2102. In some cases, a filter may prevent iron particles from escaping the desalination tank 2102. In some examples, the filter removes the expended nano media 2104, which may include oxidized iron nanoparticles as well as the solute(s) (e.g., in the form of halite) that have been captured by the nanoparticles.

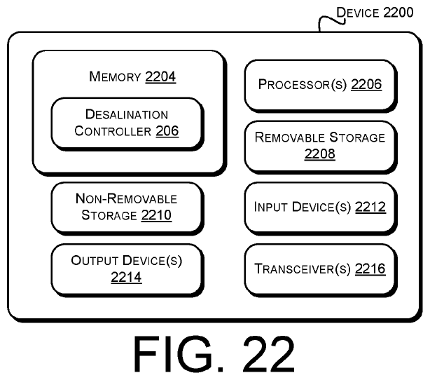

FIG. 22 illustrates at least one example device 2200 configured to enable and/or perform various functionality discussed herein. Further, the device(s) 2200 can be implemented as one or more server computers, a network element on a dedicated hardware, as a software instance running on a dedicated hardware, or as a virtualized function instantiated on an appropriate platform, such as a cloud infrastructure, and the like. It is to be understood in the context of this disclosure that the device(s) 2200 can be implemented as a single device or as a plurality of devices with components and data distributed among them.

As illustrated, the device(s) 2200 comprise a memory 2204. In various embodiments, the memory 2204 is volatile (including a component such as Random Access Memory (RAM)), non-volatile (including a component such as Read Only Memory (ROM), flash memory, etc.) or some combination of the two.

The memory 2204 may include various components, such as instructions for executing various functions of the desalination controller 206. The memory 2204 can store methods, threads, processes, applications, or any other sort of executable instructions. The memory 2204 can also store files and/or databases.

The memory 2204 may include various instructions (e.g., instructions of the desalination controller 206), which can be executed by at least one processor 2208 to perform operations. In some embodiments, the processor(s) 2208 includes a Central Processing Unit (CPU), a Graphics Processing Unit (GPU), or both CPU and GPU, or other processing unit or component known in the art.

The device(s) 2200 can also include additional data storage devices (removable and/or non-removable) such as, for example, magnetic disks, optical disks, or tape. Such additional storage is illustrated in FIG. 22 by removable storage 2210 and non-removable storage 2212. Tangible computer-readable media can include volatile and nonvolatile, removable and non-removable media implemented in any method or technology for storage of information, such as computer readable instructions, data structures, program modules, or other data. The memory 2204, removable storage 2210, and non-removable storage 2212 are all examples of computer-readable storage media. Computer-readable storage media include, but are not limited to, RAM, ROM, EEPROM, flash memory or other memory technology, CD-ROM, Digital Versatile Discs (DVDs), Content-Addressable Memory (CAM), or other optical storage, magnetic cassettes, magnetic tape, magnetic disk storage or other magnetic storage devices, or any other medium which can be used to store the desired information and which can be accessed by the device(s) 2200. Any such tangible computer-readable media can be part of the device(s) 2200.

The device(s) 2200 also can include input device(s) 2214, such as a keypad, a cursor control, a touch-sensitive display, voice input device, one or more sensors, and the like. In various cases, the device(s) 2200 include output device(s) 2216 such as a display, speakers, printers, one or more active elements (e.g., pumps, valves, heaters, etc.), and the like. In particular implementations, a user can provide input to the device(s) 2200 via a user interface associated with the input device(s) 2214 and/or the output device(s) 2216.

As illustrated in FIG. 22, the device(s) 2200 can also include one or more wired or wireless transceiver(s) 2218. For example, the transceiver(s) 2218 can include a Network Interface Card (NIC), a network adapter, a LAN adapter, or a physical, virtual, or logical address to connect to the various base stations or networks contemplated herein, for example, or the various user devices and servers. To increase throughput when exchanging wireless data, the transceiver(s) 2218 can utilize Multiple-Input/Multiple-Output (MIMO) technology. The transceiver(s) 2218 can include any sort of wireless transceivers capable of engaging in wireless, Radio Frequency (RF) communication. The transceiver(s) 2218 can also include other wireless modems, such as a modem for engaging in Wi-Fi, WiMAX, Bluetooth, or infrared communication. In some implementations, the transceiver(s) 2218 can be used to communicate between various functions, components, modules, or the like, that are comprised in the device(s) 2200.

### EXAMPLE CLAUSES

1. A desalination system, including: a first desalination vessel including: a first base; at least one first sidewall extending perpendicularly from the first base; a first lid configured removably coupled to an edge of the at least one first sidewall, and a first baffle extending from the first lid and parallel to the at least one first sidewall, wherein a first water inlet extends through the at least one first sidewall, a first water outlet extends through the at least one sidewall, a desalination media inlet extends through the lid, and at least one first gas inlet extends through the base; a desalination media source storing desalination media and being fluidly coupled with the desalination media inlet, the desalination media including iron; at least one second desalination vessel including: at least one second base; at least one second sidewall extending perpendicularly from the at least one second base; at least one second lid removably coupled to an edge of the at least one second sidewall; and at least one second baffle extending from the at least one second lid and parallel to the at least one second sidewall, wherein a second water inlet extends through the at least one second sidewall and is fluidly coupled with the first water outlet, a second water outlet extends through the at least one second sidewall, and at least one second gas inlet extends through the at least one second base; at least one gas source storing a gas and being fluidly coupled with the at least one first gas inlet and the at least one second gas inlet; a settling tank including: a third base; and at least one third sidewall extending from the third base, wherein a third water inlet extends through the at least one third sidewall and is fluidly coupled with the second water outlet, and a third water outlet extends through the at least one third sidewall; and a filter including: a housing enclosing activated carbon particles, wherein a fourth water inlet extends through the housing and is fluidly coupled with the third water outlet, and a fourth water outlet extends through the housing.
2. The desalination system of clause 1, wherein the first base is circular or rectangular, and wherein the at least one second base is circular or rectangular.
3. The desalination system of clause 1 or 2, wherein a first space is disposed between the first baffle and the first base, and wherein at least one second space is disposed between the at least one second baffle and the at least one second base.
4. The desalination system of any of clauses 1 to 3, wherein the first desalination vessel includes stainless steel and the at least one second desalination vessel includes stainless steel.
5. The desalination system of any of clauses 1 to 4, wherein the first water inlet is disposed at a higher elevation than the first water outlet, the second water outlet, and the third water outlet.
6. The desalination system of any of clauses 1 to 5, wherein the desalination media includes zero valent iron (ZVI).
7. The desalination system of any of clauses 1 to 6, wherein the desalination media includes iron nanoparticles.
8. The desalination system of any of clauses 1 to 7, wherein the at least one second desalination vessel includes multiple second desalination vessels.
9. The desalination system of any of clauses 1 to 8, wherein the gas includes air.
10. The desalination system of any of clauses 1 to 9, wherein the gas includes oxygen.
11. The desalination system of any of clauses 1 to 10, wherein the at least one gas source stores the gas at a pressure of at least 10 kilopascals (kPa).
12. The desalination system of any of clauses 1 to 11, further including: a first valve configured to emit the gas through the at least one first gas inlet at a rate of about 1 L per minute to about 2 L per minute, and at least one second valve configured to emit the gas through the at least one second gas inlet at a rate of about 1 L per minute to about 2 L per minute.
13. The desalination system of any of clauses 1 to 12, wherein the third base of the settling tank includes an expended media drain.
14. The desalination system of clause 13, further including: a valve and/or pump coupled with the expended media drain.
15. The desalination system of any of clauses 1 to 14, wherein the third base of the settling tank is cone-shaped.
16. The desalination system of any of clauses 1 to 15, further including: at least one pump coupled to a fluid path extending through the first desalination vessel, the at least one second desalination vessel, and the settling tank.
17. The desalination system of any of clauses 1 to 16, further including: a salinity sensor disposed in the fluid path; and a processor configured to: activate the at least one pump based on a salinity detected by the salinity sensor.
18. The desalination system of any of clauses 1 to 17, further including: at least one pump coupled to the desalination media inlet.
19. The desalination system of any of clauses 1 to 18, further including: a buffer source storing a buffer solution and fluidly coupled with a buffer inlet extending through the first base or the at least one first sidewall of the first desalination tank.
20. The desalination system of clause 19, further including: a pH sensor disposed in the first desalination tank; a pump or valve disposed between the buffer source and the buffer inlet; and a processor communicatively coupled with the pH sensor and the pump or valve, the processor being configured to: cause the pump or valve to release the buffer solution in the first desalination tank based on an output signal from the pH sensor, and wherein the desalination media is acidic.
21. The desalination system of any of clauses 1 to 20, wherein the settling tank further includes: a magnet.
22. The desalination system of any of clauses 1 to 21, further including: a heater connected to the first water inlet.
23. The desalination system of any of clauses 1 to 22, wherein the desalination media and the gas are configured to remove at least one solute from water that has entered the first inlet and is disposed in the first desalination tank.
24. The desalination system of clause 23, wherein the iron in the desalination media is configured to oxidize in the presence of the gas, thereby binding to the at least one solute in the water.
25. The desalination system of clause 23 or 24, wherein the at least one solute includes at least one of sodium, chloride, one or more metals, copper, zinc, manganese, aluminum, phosphate, sulfate, arsenic, selenium, nitrate, chloride, or one or more radionuclides.
26. A desalination tank, including: a base, at least one gas inlet extending through the base and being fluidly coupled with a gas source; at least one sidewall extending from the base, a water inlet extending through the at least one sidewall and a water outlet extending through the at least one sidewall; and a baffle extending in a direction that is perpendicular to the base, a space being disposed between the base and the baffle.
27. The desalination tank of clause 26, wherein the base is perpendicular to the at least one sidewall.
28. The desalination tank of clause 26 or 27, wherein the base has a circular or rectangular shape.
29. The desalination tank of any of clauses 26 to 28, wherein the at least one gas inlet includes a diffuser.
30. The desalination tank any of clauses 26 to 29, wherein the gas source is configured to release a gas into the desalination tank through the at least one gas inlet.
31. The desalination tank of clause 30, wherein the gas includes air and/or oxygen.
32. The desalination tank of clause 30 or 31, wherein the gas source is configured to release the gas into the desalination tank at a rate of about 1 to about 2 L per minute.
33. The desalination tank of any of clauses 26 to 32, wherein the baffle has a rounded end.
34. The desalination tank of any of clauses 26 to 33, wherein a volume of the desalination tank is in a range of about 1 liter (L) to about 10,000 L.
35. The desalination tank of any of clauses 26 to 34, wherein at least one desalination media inlet extends through the base and/or the at least one sidewall.
36. The desalination tank of clause 35, wherein the at least one desalination media inlet is fluidly coupled with a desalination media source configured to store desalination media and to release desalination media into the desalination tank through the at least one desalination media inlet.
37. The desalination tank of clause 36, wherein the desalination media includes zero valent iron (ZVI).
38. The desalination tank of clause 36 or 37, wherein the desalination media includes iron nanoparticles.
39. The desalination tank of any of clauses 36 to 38, wherein the desalination media is acidic.
40. The desalination tank of clause 39, wherein a buffer inlet extends through the base or the at least one sidewall, the buffer inlet being fluidly coupled with a buffer source configured to store a buffer having a pH that is greater than 7.
41. The desalination tank of clause 40, wherein the buffer includes bicarbonate.
42. The desalination tank of any of clauses 26 to 41, further including: at least one pump coupled with the water inlet and/or the water outlet.
43. The desalination tank of any of clauses 26 to 42, further including: a heater coupled with the water inlet.
44. A method, including: receiving water including at least one solute; introducing a desalination media into the water, the desalination media including zero valent iron (ZVI) nanoparticles; causing the ZVI nanoparticles to oxidize and capture the at least one solute by bubbling air into the water, thereby generating oxidized iron nanoparticles bound to the at least one solute; and removing the oxidized iron nanoparticles bound to the at least one solute from the water
45. The method of clause 44, wherein the at least one solute includes one or more metals.
46. The method of clause 45, wherein the one or more metals include at least one of copper, zinc, manganese, aluminum, selenium, or a radionuclide.
48. The method of any of clauses 44 to 47, wherein the at least one solute includes at least one of phosphate, sulfate, arsenic, nitrate, or chlorine.
49. The method of any of clauses 44 to 48, wherein the water including the at least one solute includes seawater, mining waste, industrial waste, or agricultural waste.
50. The method of any of clauses 44 to 49, wherein the desalination media further includes one or more phenols.
51. The method of any of clauses 44 to 50, wherein the desalination media has a pH that is less than 7.
52. The method of clause 51, further including: introducing a buffer solution into the water, the buffer solution having a pH that is greater than 7.
53. The method of clause 52, wherein the buffer solution includes bicarbonate.
54. The method of any of clauses 44 to 53, wherein bubbling the air includes: releasing, into a tank holding the water, the air through at least one inlet in a base of the tank.
55. The method of clause 54, the inlet being a first inlet, wherein introducing the desalination media into the water includes: releasing, into the tank holding the water, the desalination media through at least one second inlet in the base or a sidewall of the tank.
56. The method of any of clauses 44 to 55, wherein bubbling the air includes: releasing, into the water, the air at a rate of about 1 L per minute to about 2 L per minute.
57. The method of any of clauses 44 to 56, wherein bubbling the air includes: releasing, into the water, the air at a pressure of about 10 kPa to about 14 kPa.
58. The method of any of clauses 44 to 57, wherein introducing the desalination media into the water is performed simultaneously with bubbling the air.
59. The method of any of clauses 44 to 58, wherein removing the oxidized iron nanoparticles bound to the at least one solute from the water includes: removing sludge including the oxidized iron nanoparticles bound to the at least one solute from a bottom of a settling tank.
60. The method of any of clauses 44 to 59, wherein removing the oxidized iron nanoparticles bound to the at least one solute from the water includes: filtering, by activated carbon particles, the oxidized iron nanoparticles bound to the at least one solute from the water.
61. The method of any of clauses 44 to 60, further including: in response to removing the oxidized iron nanoparticles bound to the at least one solute from the water, outputting the water, wherein a concentration of the at least one solute in the water being output is less than 30% of a concentration of the at least one solute in the water being received.
62. The method of any of clauses 44 to 61, further including: heating the water to a temperature that is greater than 20° C.
63. A desalination system, including: a first desalination vessel configured to: receive an inflow of water including chloride ions and sodium ions, receive iron nanoparticles, receive diffused air, produce desalinated water by causing the diffused air to move countercurrent with the water and the iron nanoparticles such that at least a portion of the chloride ions and at least a portion of the sodium ions are retained by the iron nanoparticles, and discharge the desalinated water; and a second desalination vessel configured to receive the desalinated water from the first desalination vessel.
64. The desalination system of clause 63, wherein the second desalination vessel is configured to cause the desalinated water to contact additional iron nanoparticles.
65. The desalination system of clause 63 or 64, wherein the iron nanoparticles are introduced to the first desalination vessel as a slurry of the iron nanoparticles.
66. The desalination system of clause 65, wherein the inflow of the water and the slurry are received proximate to an upper end of the first desalination vessel.
67. The desalination system of any of clauses 63 to 66, wherein the diffused air is received proximate to a lower end of the first desalination vessel.
68. The desalination system of any of clauses 63 to 67, wherein the desalinated water is discharged proximate to an upper end of the first desalination vessel.
69. The desalination system of any of clauses 63 to 68, wherein the first desalination vessel is further configured to separate the desalinated water from a waste product, the waste product including at least some of the iron nanoparticles, the portion of the chloride ions, and the portion of the sodium ions that are retained by the iron nanoparticles.
70. The desalination system of clause 69, wherein the first desalination vessel is configured to retain the waste product proximate to a lower end of the first desalination vessel.
71. The desalination system of any of clauses 63 to 70, wherein the iron nanoparticles include zero valent iron (ZVI).
72. A desalination system, including: a first desalination vessel, a length of the first desalination vessel being longer than a width of the first desalination vessel, the first desalination vessel including: a first inlet port configured to receive an inflow of water including chloride ions and sodium ions, a second inlet port configured to receive iron nanoparticles, a third inlet port configured to receive diffused air, the third inlet port being spaced apart from the first inlet by a distance along a direction parallel to the length of the first desalination vessel, the distance being greater than half the length of the vessel, the first desalination vessel being configured to produce desalinated water by causing the diffused air to move countercurrent with the water and the iron nanoparticles such that at least a portion of the chloride ions and at least a portion of the sodium ions are retained by the iron nanoparticles, and an outlet port configured to discharge the desalinated water; and a second desalination vessel configured to receive the desalinated water from the first desalination vessel.
73. A desalination vessel, including: an influent side for receiving iron nanoparticles and water containing chloride ions and sodium ions; an effluent side for dispensing desalinated water; a baffle forming the influent side and the effluent side of the desalination vessel, the baffle being configured to: direct the water from an upper end of the influent side to a lower end of the desalination vessel causing at least a portion of the chloride ions and at least a portion of the sodium ions to become associated with the iron nanoparticles, thereby producing desalinated water, and direct the desalinated water from the lower end of the desalination vessel to an upper end of the effluent side; and an outlet proximate the lower end of the desalination vessel for removing the iron nanoparticles.

### CONCLUSION

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; +18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

What is claimed is:

1. A desalination system, comprising:
a first desalination vessel comprising:
a first base;
at least one first sidewall extending perpendicularly from the first base;
a first lid configured removably coupled to an edge of the at least one first sidewall, and
a first baffle extending from the first lid and parallel to the at least one first sidewall,
wherein a first water inlet extends through the at least one first sidewall, a first water outlet extends through the at least one sidewall, a desalination media inlet extends through the lid, and at least one first gas inlet extends through the base;
a desalination media source storing desalination media and being fluidly coupled with the desalination media inlet, the desalination media comprising iron;
at least one second desalination vessel comprising:
at least one second base;
at least one second sidewall extending perpendicularly from the at least one second base;
at least one second lid removably coupled to an edge of the at least one second sidewall; and
at least one second baffle extending from the at least one second lid and parallel to the at least one second sidewall,
wherein a second water inlet extends through the at least one second sidewall and is fluidly coupled with the first water outlet, a second water outlet extends through the at least one second sidewall, and at least one second gas inlet extends through the at least one second base;
at least one gas source storing a gas and being fluidly coupled with the at least one first gas inlet and the at least one second gas inlet;
a settling tank comprising:
a third base; and
at least one third sidewall extending from the third base,
wherein a third water inlet extends through the at least one third sidewall and is fluidly coupled with the second water outlet, and a third water outlet extends through the at least one third sidewall; and
a filter comprising:
a housing enclosing activated carbon particles,
wherein a fourth water inlet extends through the housing and is fluidly coupled with the third water outlet, and a fourth water outlet extends through the housing.

2. The desalination system of claim 1, wherein the first base is circular or rectangular, and wherein the at least one second base is circular or rectangular.

3. The desalination system of claim 1, wherein a first space is disposed between the first baffle and the first base, and
wherein at least one second space is disposed between the at least one second baffle and the at least one second base.

4. The desalination system of claim 1, wherein the first desalination vessel comprises stainless steel and the at least one second desalination vessel comprises stainless steel.

5. The desalination system of claim 1, wherein the first water inlet is disposed at a higher elevation than the first water outlet, the second water outlet, and the third water outlet.

6. The desalination system of claim 1, wherein the desalination media comprises zero valent iron (ZVI).

7. The desalination system of claim 1, wherein the desalination media comprises iron nanoparticles.

8. The desalination system of claim 1, wherein the at least one second desalination vessel comprises multiple second desalination vessels.

9. The desalination system of claim 1, wherein the gas comprises air.

10. The desalination system of claim 1, wherein the gas comprises oxygen.

11. The desalination system of claim 1, wherein the at least one gas source stores the gas at a pressure of at least 10 kilopascals (kPa).

12. The desalination system of claim 1, further comprising:
a first valve configured to emit the gas through the at least one first gas inlet at a rate of about 1 L per minute to about 2 L per minute, and
at least one second valve configured to emit the gas through the at least one second gas inlet at a rate of about 1 L per minute to about 2 L per minute.

13. The desalination system of claim 1, wherein the third base of the settling tank comprises an expended media drain.

14. The desalination system of claim 13, further comprising:
a valve and/or pump coupled with the expended media drain.

15. The desalination system of claim 1, wherein the third base of the settling tank is cone-shaped.

16. The desalination system of claim 1, further comprising:
at least one pump coupled to a fluid path extending through the first desalination vessel, the at least one second desalination vessel, and the settling tank.

17. The desalination system of claim 16, further comprising:
a salinity sensor disposed in the fluid path; and
a processor configured to:
activate the at least one pump based on a salinity detected by the salinity sensor.

18. The desalination system of claim 1, further comprising:
at least one pump coupled to the desalination media inlet.

19. The desalination system of claim 1, further comprising:
a buffer source storing a buffer solution and fluidly coupled with a buffer inlet extending through the first base or the at least one first sidewall of the first desalination tank.

20. The desalination system of claim 19, further comprising:
a pH sensor disposed in the first desalination tank;
a pump or valve disposed between the buffer source and the buffer inlet; and
a processor communicatively coupled with the pH sensor and the pump or valve, the processor being configured to:
cause the pump or valve to release the buffer solution in the first desalination tank based on an output signal from the pH sensor, and
wherein the desalination media is acidic.

21. The desalination system of claim 1, wherein the settling tank further comprises:
a magnet.

22. The desalination system of claim 1, further comprising:
a heater connected to the first water inlet.

23. The desalination system of claim 1, wherein the desalination media and the gas are configured to remove at least one solute from water that has entered the first inlet and is disposed in the first desalination tank.

24. The desalination system of claim 23, wherein the iron in the desalination media is configured to oxidize in the presence of the gas, thereby binding to the at least one solute in the water.

25. The desalination system of claim 23, wherein the at least one solute comprises at least one of sodium, chloride, one or more metals, copper, zinc, manganese, aluminum, phosphate, sulfate, arsenic, selenium, nitrate, chloride, or one or more radionuclides.

26. A desalination tank, comprising:
a base, at least one gas inlet extending through the base and being fluidly coupled with a gas source;
at least one sidewall extending from the base, a water inlet extending through the at least one sidewall and a water outlet extending through the at least one sidewall; and
a baffle extending in a direction that is perpendicular to the base, a space being disposed between the base and the baffle.

27. The desalination tank of claim 26, wherein the base is perpendicular to the at least one sidewall.

28. The desalination tank of claim 26, wherein the base has a circular or rectangular shape.

29. The desalination tank of claim 26, wherein the at least one gas inlet comprises a diffuser.

30. The desalination tank of claim 26, wherein the gas source is configured to release a gas into the desalination tank through the at least one gas inlet.

31. The desalination tank of claim 30, wherein the gas comprises air and/or oxygen.

32. The desalination tank of claim 30, wherein the gas source is configured to release the gas into the desalination tank at a rate of about 1 to about 2 L per minute.

33. The desalination tank of claim 26, wherein the baffle has a rounded end.

34. The desalination tank of claim 26, wherein a volume of the desalination tank is in a range of about 1 L to about 10,000 L.

35. The desalination tank of claim 26, wherein at least one desalination media inlet extends through the base and/or the at least one sidewall.

36. The desalination tank of claim 35, wherein the at least one desalination media inlet is fluidly coupled with a desalination media source configured to store desalination media and to release desalination media into the desalination tank through the at least one desalination media inlet.

37. The desalination tank of claim 36, wherein the desalination media comprises zero valent iron (ZVI).

38. The desalination tank of claim 36, wherein the desalination media comprises iron nanoparticles.

39. The desalination tank of claim 36, wherein the desalination media is acidic.

40. The desalination tank of claim 39, wherein a buffer inlet extends through the base or the at least one sidewall, the buffer inlet being fluidly coupled with a buffer source configured to store a buffer having a pH that is greater than 7.

41. The desalination tank of claim 40, wherein the buffer comprises bicarbonate.

42. The desalination tank of claim 26, further comprising:
at least one pump coupled with the water inlet and/or the water outlet.

43. The desalination tank of claim 26, further comprising:
a heater coupled with the water inlet.

44. A method, comprising:
receiving water comprising at least one solute;
introducing a desalination media into the water, the desalination media comprising zero valent iron (ZVI) nanoparticles;
causing the ZVI nanoparticles to oxidize and capture the at least one solute by bubbling air into the water, thereby generating oxidized iron nanoparticles bound to the at least one solute; and
removing the oxidized iron nanoparticles bound to the at least one solute from the water.

45. The method of claim 44, wherein the at least one solute comprises one or more metals.

46. The method of claim 45, wherein the one or more metals comprise at least one of copper, zinc, manganese, aluminum, selenium, or a radionuclide.

47. The method of claim 44, wherein the at least one solute comprises sodium and/or chloride.

48. The method of claim 44, wherein the at least one solute comprises at least one of phosphate, sulfate, arsenic, nitrate, or chlorine.

49. The method of claim 44, wherein the water comprising the at least one solute comprises seawater, mining waste, industrial waste, or agricultural waste.

50. The method of claim 44, wherein the desalination media further comprises one or more phenols.

51. The method of claim 44, wherein the desalination media has a pH that is less than 7.

52. The method of claim 51, further comprising:
introducing a buffer solution into the water, the buffer solution having a pH that is greater than 7.

53. The method of claim 52, wherein the buffer solution comprises bicarbonate.

54. The method of claim 44, wherein bubbling the air comprises:
releasing, into a tank holding the water, the air through at least one inlet in a base of the tank.

55. The method of claim 54, the inlet being a first inlet, wherein introducing the desalination media into the water comprises:
releasing, into the tank holding the water, the desalination media through at least one second inlet in the base or a sidewall of the tank.

56. The method of claim 44, wherein bubbling the air comprises:
releasing, into the water, the air at a rate of about 1 L per minute to about 2 L per minute.

57. The method of claim 44, wherein bubbling the air comprises:
releasing, into the water, the air at a pressure of about 10 kPa to about 14 kPa.

58. The method of claim 44, wherein introducing the desalination media into the water is performed simultaneously with bubbling the air.

59. The method of claim 44, wherein removing the oxidized iron nanoparticles bound to the at least one solute from the water comprises:
removing sludge comprising the oxidized iron nanoparticles bound to the at least one solute from a bottom of a settling tank.

60. The method of claim 44, wherein removing the oxidized iron nanoparticles bound to the at least one solute from the water comprises:
filtering, by activated carbon particles, the oxidized iron nanoparticles bound to the at least one solute from the water.

61. The method of claim 44, further comprising:
in response to removing the oxidized iron nanoparticles bound to the at least one solute from the water, outputting the water,
wherein a concentration of the at least one solute in the water being output is less than 30% of a concentration of the at least one solute in the water being received.

62. The method of claim 44, further comprising:
heating the water to a temperature that is greater than 20° C.

63. A desalination system, comprising:
a first desalination vessel configured to:
receive an inflow of water including chloride ions and sodium ions,
receive iron nanoparticles,
receive diffused air,
produce desalinated water by causing the diffused air to move countercurrent with the water and the iron nanoparticles such that at least a portion of the chloride ions and at least a portion of the sodium ions are retained by the iron nanoparticles, and
discharge the desalinated water; and
a second desalination vessel configured to receive the desalinated water from the first desalination vessel.

64. The desalination system of claim 63, wherein the second desalination vessel is configured to cause the desalinated water to contact additional iron nanoparticles.

65. The desalination system of claim 63, wherein the iron nanoparticles are introduced to the first desalination vessel as a slurry of the iron nanoparticles.

66. The desalination system of claim 65, wherein the inflow of the water and the slurry are received proximate to an upper end of the first desalination vessel.

67. The desalination system of claim 63, wherein the diffused air is received proximate to a lower end of the first desalination vessel.

68. The desalination system of claim 63, wherein the desalinated water is discharged proximate to an upper end of the first desalination vessel.

69. The desalination system of claim 63, wherein the first desalination vessel is further configured to separate the desalinated water from a waste product, the waste product comprising at least some of the iron nanoparticles, the portion of the chloride ions, and the portion of the sodium ions that are retained by the iron nanoparticles.

70. The desalination system of claim 69, wherein the first desalination vessel is configured to retain the waste product proximate to a lower end of the first desalination vessel.

71. The desalination system of claim 63, wherein the iron nanoparticles comprise zero valent iron (ZVI).

72. A desalination system, comprising:
a first desalination vessel, a length of the first desalination vessel being longer than a width of the first desalination vessel, the first desalination vessel comprising:
a first inlet port configured to receive an inflow of water including chloride ions and sodium ions,
a second inlet port configured to receive iron nanoparticles,
a third inlet port configured to receive diffused air, the third inlet port being spaced apart from the first inlet by a distance along a direction parallel to the length of the first desalination vessel, the distance being greater than half the length of the vessel, the first desalination vessel being configured to produce desalinated water by causing the diffused air to move countercurrent with the water and the iron nanoparticles such that at least a portion of the chloride ions and at least a portion of the sodium ions are retained by the iron nanoparticles, and
an outlet port configured to discharge the desalinated water; and
a second desalination vessel configured to receive the desalinated water from the first desalination vessel.

73. A desalination vessel, comprising:
an influent side for receiving iron nanoparticles and water containing chloride ions and sodium ions;
an effluent side for dispensing desalinated water;
a baffle forming the influent side and the effluent side of the desalination vessel, the baffle being configured to:
direct the water from an upper end of the influent side to a lower end of the desalination vessel causing at least a portion of the chloride ions and at least a portion of the sodium ions to become associated with the iron nanoparticles, thereby producing desalinated water, and direct the desalinated water from the lower end of the desalination vessel to an upper end of the effluent side; and
an outlet proximate the lower end of the desalination vessel for removing the iron nanoparticles.
